(19) United States
(12) Patent Application Publication
(10) Pub. No.: US 2019/0353067 A1
(43) Pub. Date: Nov. 21, 2019

(54) EXHAUST TREATMENT SYSTEMS AND METHODS INVOLVING OXYGEN SUPPLEMENTATION AND HYDROCARBON TRAPPING

(71) Applicant: UMICORE AG & CO. KG, Hanau-Wolfgang (DE)

(72) Inventors: David MOSER, Ortonville, MI (US); John NUNAN, Tulsa, OK (US); Chad ALLTIZER, Broken Arrow, OK (US)

(73) Assignee: UMICORE AG & CO. KG, Hanau-Wolfgang (DE)

(21) Appl. No.: 15/983,290

(22) Filed: May 18, 2018

(51) Int. Cl. F01N 3/08; F01N 3/30; F01N 3/10; B01D 53/94; B01J 29/072; B01J 35/04; B01J 29/82; B01J 23/46

(52) U.S. Cl. CPC F01N 3/0835; F01N 3/30; F01N 3/101; F01N 3/0814; B01D 53/945; B01J 29/072; B01D 2255/912; B01J 29/82; B01J 23/464; B01D 2255/50; B01D 2255/1023; B01D 2255/20738; B01D 2255/1025; B01J 35/04

(57) ABSTRACT

An exhaust treatment apparatus and method for providing a controlled and well-timed feeding of supplemental oxygen to offset low oxygen content in exhaust flow passing over a desorbing hydrocarbon trap that previously accumulated hydrocarbons during a cold start cycle. Included is an ambient air injection system and associated control unit to offset the lacking oxygen level upstream of a reaction area for a downstream uf-HCT (preferably catalyzed with TWC material) with the exhaust placed in a lean state upon contact with the uf-HCT. An air injection embodiment makes use of preexisting vehicle components as to provide for a minimization of added components to a vehicle, while still addressing the need to clean-up exhaust emissions in an effort to satisfy stringent emission control requirements, such as those set forth in LEVIII.

An exhaust treatment system and a process for the abatement of noxious pollutants being emitted from combustion devices, such as gasoline-powered combustion engines, are featured. The exhaust treatment system is inclusive of an exhaust system that comprises an oxygen supplementation device, as in a supplemental or secondary air injection system, that feeds an underfloor hydrocarbon trap (uf-HCT). The uf-HCT is preferably a catalyzed HCT (as in one provided with a three-way-catalyst (TWC) and/or oxidation catalyst (OC)), and is also preferably operated in combination with one or more upstream (close coupled) catalysts, as in a TWC (cc-TWC). A control system controls, in conjunction with inputs, as from a sensing system and/or modeling source, the providing of supplemental oxygen in strategic fashion relative to the uf-HCT, in an effort to satisfy stringent emission regulations, inclusive of the regulated combined non-methane hydrocarbon and nitrogen oxide (nMHC+NOx or NMOG+NOx) summed levels.

The present invention is further inclusive of systems for reducing harmful exhaust gas components of combustion devices such as gasoline-powered combustion engines, and to corresponding methods for exhaust gas purification. Invention systems are inclusive of a system characterized by a combination of an underfloor hydrocarbon trap (uf-HCT), a strategically positioned (e.g., upstream) controlled oxygen supply means (e.g., an ambient air oxygen supply source) feeding to the uf-HCT, one or more upstream catalyst(s), as in one or more close coupled three-way-catalysts (cc-TWC), and preferably a catalyst associated with the uf-HCT, as in a TWC or OC, separate from, or directly supported on, the uf-HCT. A control unit and associated sensing means and/or modeling source provides for coordinated supply of supplemental oxygen which reacts within the uf-HCT at the appropriate starting point and timeframe (e.g., starting upon, after, or a predetermined period just prior, to a desorption initiation at the uf-HCT, and functioning for a period suitable to achieve the desired exhaust treatment effect).

### BACKGROUND OF THE INVENTION

The exhaust gas of combustion engines in motor vehicles typically contains harmful carbon monoxide (CO), hydrocarbons (HC), nitrogen oxides (NOx) and possibly sulfur oxides (SOx), as well as particulates that mostly consist of soot residues and possibly adherent organic agglomerates. The pollutants CO, HC, and particulates are the products of the incomplete combustion of the fuel inside the combustion chamber of the engine. Nitrogen oxides form in the cylinder from nitrogen and oxygen in the intake air when the combustion temperatures locally reach a high enough temperature. Sulfur oxides result from the combustion of organic sulfur compounds, small amounts of which are present, for example, in non-synthetic fuels. For the removal of these emissions, that are harmful to health and environment, from the exhaust gases of motor vehicles, a variety of catalytic technologies for the purification of exhaust gases have been developed, the fundamental principle of which is usually based upon guiding the exhaust gas that needs purification over a catalyst, often consisting of a flow-through or wall-flow honeycomb-like body and a catalytically active coating applied to it. This catalyst facilitates the chemical reaction of different exhaust gas components, while forming non-hazardous products like carbon dioxide and water. The mode of operation and the composition of the catalysts that are used differ significantly depending upon the composition of the exhaust gas to be purified and the exhaust gas temperature level that is to be expected at the catalyst. A variety of compositions used as catalytically active coatings contain components, in which, under certain operating conditions, one or more exhaust gas components can be temporarily bound and, when an appropriate change in operating conditions occurs, be intentionally released again. Components with such a capacity are generally referred to below as storage or trapping material components.

Exhaust gases from internal combustion engines operated with a predominantly stoichiometric air/fuel (A/F) mixture, like, e.g., port-fuel injection (PFI) engines and gasoline direct engines (GDI), are cleaned according to conventional methods such as with the aid of three-way catalytic (TWC) converters. A TWC is capable of converting the three essentially gaseous pollutants of the engine, specifically hydrocarbons, carbon monoxide, and nitrogen oxides, simultaneously to harmless components. In other words, TWC's used in gasoline engine perform three main functions: (1) oxidation of CO; (2) oxidation of unburnt hydrocarbons; and (3) reduction of NOx to Nz.

Furthermore, for many gasoline engines, aftertreatment of the exhaust gases involving TWC(s) are also combined with engine management of air fuel ratios in an effort to facilitate reductions by TWCs of carbon monoxide, hydrocarbon and nitrogen oxides pollutants and/or fuel conservation. Most TWC designs are set up to be most efficient when exposed to exhaust from an engine running slightly below stoichiometric point or slightly rich. That is, catalysts are most efficient when exposed to slightly rich of stoichiometric AFR's, which would be on the order of 0.998-0.995 lambda (0.2-0.5% rich). AFR's slightly lean of stoichiometric (λ>1) result in poorer NOx control, but provide better fuel conservation. Toggling AFR's as between 14.6 and 14.8 parts air to 1 part fuel, by weight, for gasoline fueled internal combustion engines is generally done for emissions only as it balances the oxidation of HC and CO with the reduction of NOx, using the OSC in the catalyst. If conserving fuel were the only goal (e.g., no NOx emissions control), strictly lean AFR's would be used. Furthermore, to be effective the TWC generally requires the temperature of the exhaust gas to be not lower than 300° C. during the toggling of AFR around stoichiometric. As described in US 2016/0228818 to Chang et al., for cold start hydrocarbon control, hydrocarbon (HC) traps, such as those utilizing zeolites as hydrocarbon trapping components, have been investigated. In these systems, the molecular sieve zeolite component adsorbs and stores hydrocarbons during the start-up period and rapidly releases the stored hydrocarbons when the exhaust temperature is high enough to desorb hydrocarbons. The desorbed hydrocarbons are subsequently converted by a TWC component either incorporated into the HC trap or by a separate TWC placed downstream of the HC trap.

However, even with the benefit of a TWC and engine management relative to the air fuel ratios in the exhaust output from the engine, many engine systems fail to satisfy imposed emission values, particularly those being currently regulated for future compliance. A particularly difficult issue, relative to the emission standards, is the regulated combination of non-methane hydrocarbons (or nMHC's) plus (NOx) emissions such as those found in the light-off of HC's previously trapped during the engine cold start phase (wherein there is a substantial release phase subsequent to the trapping stage which occurs when the temperature rises to a level leading to the desorption of the previously trapped HC's).

For example, the US State of California has imposed stringent LEVIII emission regulations, inclusive of a combined (non-methane organic gas+nitrogen oxides) or (nMOG+NOx) standard approaching 30 mg/mi by the year 2025. The US Federal Environmental Protection Agency has also imposed similar stringent restrictions on the noted nMOG+NOx (or depending on the fuel usage non-methane hydrocarbons+nitrous oxides or nMHC+NOx). A difference between the noted NMOG and NMHC, is that NMOG refers to fuels containing ingredients such as ethanol (additives such as E85 or E10). These NMOG related components are often referred to as oxygenates in the exhaust. The NMOG standard is more difficult to meet in conventional catalyst systems, as emissions associated with oxygenates, such as ethanol and acetaldehyde, are difficult to convert over a conventional TWC catalyst. In either situation, the catalyst light-off period of the Federal Test Protocol (FTP) cycle continues to be both one of the main contributors to overall emissions, and challenges in meeting these more stringent standards.

As a method of reducing hydrocarbon emissions using an HCT and supplemental air supply, reference is made to U.S. Pat. No. 6,000,217 of Hochmuth which features, in a preferred embodiment, an HCT with a downstream, supplemental air supplier that supplies air to the desorbed HC's passing downstream of the HCT in an effort to place that exhaust in a stoichiometric state prior to reaching an even farther downstream uf-TWC. Despite the downstream uf-TWC being described in Hochmuth as the preferred approach (relative to the other tested arrangements described, for example, in the examples in Column 11 of this patent) the considered problem with this approach is that a TWC downstream of an HCT will be cold when the upstream HCT releases its stored HC's. Injecting air may result in a small amount of HC oxidation in the gas stream itself, but this will be minimal, since the injected air is relatively cool. The air injection will also further inhibit a downstream TWC from lighting off. Thus, under the preferred approach described in Hochmuth, very little HC oxidation would occur on a standard downstream TWC.

The PCT publication WO01/90541 describes a further example of a downstream, supplemental air supplier positioned downstream of a HCT, wherein air is supplied at a location downstream of the HCT in order to add oxygen to the upstream released hydrocarbons for emission treatment.

In FIGS. 1 and 1A of the present application there is further shown an example of an attempt in the industry to address the issue of desorbed HC during light-off (following adsorption of an HCT during the cold stage), involving the use of a cc-TWC followed by a passive uf-HC trap in an underfloor position having a zeolite underlayer for HCT functioning and an overlayer of TWC catalyst. That is, as schematically shown in FIGS. 1 and 1A, there is featured an exhaust treatment system 20 with engine 22 supplying exhaust to catalyst system 24 comprising close coupled TWC (cc-TWC) 26 which feeds into downstream underfloor hydrocarbon trap (uf-HCT) 28 featuring a two layer combination of underlayer L1 (zeolite-HCT) and overlayer L2 (TWC) supplied on supporting substrate 29.

However, the performance potential of a passive HC trap in an UF (UF short for underfloor which is used interchangeably in the present application with the term underbody or “UB”) exhaust position with respect to its ability to convert HC's is a strong function of availability of oxygen during the desorption phase. As noted above, after HC's are trapped during the engine cold start phase, a release phase subsequently occurs during which HC's desorb from the HC trap as a function of its temperature. In order for the desorbing HC's to be efficiently converted into H₂O and CO₂, oxygen availability is paramount. However, the present invention takes recognition of the notion that the vast majority of “engine out” exhaust oxygen content levels, during the desorption phase, are deficient for desorbed HC conversion; as due, for example, to the O₂ having recently been consumed by the reactions taking place in the upstream CC converter (with “CC” being in reference to the term “close coupled” as recognized in the art, and described in greater detail below), resulting in a shortage of O₂ availability to the uf-HC trap. In other words, the present invention also takes recognition of the problem that efficient cc-TWC's currently being used, while providing for improvements in emission removal during many stages of operation, have high efficiencies that can lead to the problem of high oxygen consumption in the CC region, which leads to a lack of sufficient oxygen downstream for conversion of desorbed HCs during HCT light-off.

One considered solution to this problem is the utilization of Deceleration Fuel Cutoff (DFCO) which leads to an increase in oxygen levels in the exhaust. Typically, a deceleration fuel cut event starts with stoppage of fuel to the cylinders when power is not required, e.g., during a deceleration period of a vehicle. In this mode, the engine operates as an air pump, drawing in ambient air into the cylinders, and expelling it through the exhaust system such that a leaner exhaust results. DFCO thus provides some oxygen to the UF region during this desorption phase for a limited number of applications. However, many gasoline engines do not go into DFCO mode during the desorption phase. These systems do not “turn on” (i.e., meet the criteria for activation) DFCO until well after the desorption phase of the HC trap has taken place. Further DFCO's are typically very short lived. Thus, there is a need for a new approach to this issue that does not rely on DFCO alone.

### SUMMARY OF INVENTION FEATURES

In an embodiment of the invention, a secondary air injection system is fitted to the vehicle, preferably utilizing pre-existing original equipment manufacturer (or OEM) production level components. The secondary or supplemental air injection system is plumbed into the exhaust system, such that ambient air (79% N2/21% O₂) is introduced upstream of the uf-HCT assembly. A control system is integrated with the hardware, such that the pump can be controlled to turn on and off automatically as a function of various engine operating parameters. During the HC trap desorption phase, air is injected upstream of the HC trap, which improves HC conversion during the desorption phase; and, thus, overall HC conversion efficiency of the HC trap. The control system can be tuned to correspond to the desorption phase as a function of a variety of engine parameters (e.g., engine run time, (engine current temperature) ECT, (ambient air temperature) AAT, time since last shut off, etc.)

A uf-TWC, when utilized, with the uf-HCT can have the same characteristics as, or can be different than, a TWC upstream, when utilized, as in a TWCcc (e.g., the CC and UB TWC material can be of different composition due to the different exhaust temperatures and λ values experienced between a cc-component and an uf-component, or the same).

An example of a suitable TWC (uf or cc) is described in WO2016/116356 to Umicore AG, as well as US Publication No. US 2016/0121267, each of which publications is incorporated herein by reference for background purposes.

The present invention is inclusive of the following examples:

(Example Point 1) A system for a gasoline engine exhaust emission reduction, comprising:
an underfloor hydrocarbon trap (uf-HCT),
a supplemental (e.g., supplemental to a primary engine-in air flow system) oxygen supply apparatus feeding oxygen to the uf-HCT,
a control unit in communication with the supplemental oxygen supply apparatus as to feed excess oxygen to the uf-HCT during a time of HC desorption from the uf-HCT and wherein the control unit feeds the excess oxygen to the uf-HCT as to place the exhaust flow in contact with the uf-HCT in a lean state during HC desorption.

(Example Point 2) The system of Example Point 1 further comprising an added catalyzing material provided on the uf-HCT as to promote the reduction of HC during the time of both HC desorption from the uf-HCT and control unit supplied excess oxygen.

(Example Point 3) The system of Example Points 1 or 2 further comprising one or more upstream catalyst(s) relative to the uf-HCT.

(Example Point 4) The system of any one of Example Points 1 to 3 wherein one or more catalyst(s) positioned upstream of the uf-HCT is/are provided and include(s) at least one TWC close coupled catalyst.

(Example Point 5) The system of any one of Example Points 1 to 4 wherein (the) added catalyzing material includes a TWC coating layer provided on the uf-HCT.

(Example Point 6) The system of any one of Example Points 1 to 5 wherein the control unit receives input from either or both of (i) one or more sensor units, and (ii) a pre-modeled input source, as to establish an anticipated or an on-going state of HC desorption from the uf-HCT and a signal generator as to promote oxygen feed from the supplemental oxygen supply apparatus.

(Example Point 7) The system of any one of Example Points 1 to 6 wherein the supplemental oxygen supply apparatus comprises an air feed assembly.

(Example Point 8) The system of any one of Example Points 1 to 7 wherein an (or the) air feed assembly feeds ambient air to the uf-HCT.

(Example Point 9) The system of any one of Example Points 1 to 8 wherein the engine is a gasoline engine selected from the group consisting of a port-fuel injection (PFI) engine, a stratified charge engine (SCE), a gasoline direct engine (GDI), a dual injection system engine (PFI+GDI), a gasoline direct injection compression ignition engine (GDCI), an engine with start stop control reception, or an engine which is a component of a vehicle multi-power drive system.

(Example Point 10) The system of any one of Example Points 1 to 9 wherein at least a component of an (or the) air feed assembly shares a component of an air feed system to the engine.

(Example Point 11) The system of Example Point 10 wherein the component of the air feed assembly shared with the air feed system feeding into the engine includes a vacuum exhaust valve.

(Example Point 12) The system of any one of Example Points 1 to 11 wherein the control unit is configured to have the supplemental oxygen supply apparatus present over the uf-HCT at a mass flow rate of injected air (as from a pump source) into the exhaust passing over the uf-HCT of 1 to 30 L/s (with 5 to 20 L/s as well as 10 (+/−2.5) L/s being well suited for some system arrangements).

(Example Point 13) The system of any one of Example Points 1 to 12 wherein the uf-HCT comprises a micro-sieve material as well as a PGM metal, such as Pd.

(Example Point 14) The system of any one of Example Points 1 to 13 wherein the uf-HCT (further) comprises a catalyzing material that includes a TWC coating layer provided on the uf-HCT, as wherein the TWC coating comprises Rh.

(Example Point 15) The system of any one of Example Points 1 to 14 wherein the control unit times a supplemental oxygen supply period until there is sufficient oxygen in the exhaust to enable a removal of a predominate amount of HC or all of the HC that has been released from the uf-HCT during a desorption period of HC from the uf-HCT.

(Example Point 16) A system for a gasoline engine exhaust emission reduction, comprising:
an underfloor hydrocarbon trap (uf-HCT),
means for supply supplemental oxygen to the uf-HCT,
a control unit in communication with the means for supplying oxygen to the uf-HCT during a time of HC desorption from the uf-HCT as to render the exhaust travelling over the uf-HCT lean during the HC desorption.

(Example Point 17) A method of assembling the system of any one of Example Points 1 to 16, comprising:
presenting a hydrocarbon trap (HCT) in an underbody position (uf-HCT) of a vehicle exhaust conduit,
presenting a supplemental oxygen supply apparatus as to feed supplemental oxygen to the uf-HCT,
presenting a control unit in communication with the supplemental oxygen supply apparatus configured as to feed oxygen to the uf-HCT during a time of HC desorption from the uf-HCT as to place the exhaust in a lean state over the uf-HCT during the HC desorption.

(Example Point 18) The method of Example Point 17 further comprising presenting a close coupled TWC (cc-TWC) and the uf-HCT as a catalyzed uf-HCT with both a PGM, as in Pd, and a base metal as in Fe, and a TWC coating with a PGM as in Rh.

(Example Point 19) A method of operating the system of any one of Example Points 1 to 16 comprising passing exhaust gas over the uf-HCT and controlling the supply of supplemental oxygen to the uf-HCT by operation of the control unit and the supplemental oxygen supply apparatus as to present a lean exhaust flow for the removal of desorbing hydrocarbons from the exhaust flow.

### BRIEF DESCRIPTION OF THE DRAWINGS

FIG. 1 shows a schematic view of a conventional approach of removing pollutants from an exhaust flow.

FIG. 1A shows a layering schematic for the uf-HCT shown in FIG. 1.

FIG. 2 shows a schematic illustration of the exhaust emission system of the present invention, with “box” depiction of the after-exhaust system of the present invention forming a part of a combustion assembly that further comprises the schematically shown gasoline engine (with associated controls and sensors).

FIG. 3 shows a schematic view of a first configuration of the after-exhaust system depicted in FIG. 2.

FIG. 3A shows a potential layered configuration of the uf-HCT in FIG. 3.

FIG. 4 shows a more detailed view of components of the first configuration schematically shown in FIG. 3.

FIG. 5 shows the various phases relative to time v. miles per hour (mph) testing associated with the EPA's Federal Testing Program (FTP-75) which is used for LEVIII and Tier 3 emission control level determinations.

FIG. 6 provides test data over a period of 500 seconds of an FTP test run for an exhaust system with the test data including engine exhaust lambda (λ) levels during that time period, the roll speed and an illustration as to how DFCO or fuel cuts start only after the end of the desorption zone so as not to help in supplying oxygen to the exhaust passing over the desorbing HCT.

FIG. 7 shows a schematic representation of the after-exhaust system shown in FIG. 3 with associated control means, supplemental air injection means, and electrical line framework.

FIG. 8 provides test data over a period of 500 seconds of an FTP test run for an exhaust system featuring the system of FIG. 3 with the test data including i) the adsorption, air injection and desorption zones, ii) the cumulative amount of HC (“THC”) in the emission, and iii) the HCT's temperature levels during that time period.

FIG. 9 provides test data over a period of 500 seconds of an FTP test run for an exhaust system featuring the system of FIG. 3 with the test data including O₂ levels entering the HCT during that time period (both with the present invention's controlled air supplementation system in operation and not in operation such that there can be seen how there is no oxygen present with the stock calibration due to lack of fuel cuts).

FIG. 10 shows an additional inventive arrangement featuring additional after-exhaust components relative to the FIG. 3 configuration that is inclusive of a cc-TWC, a supplemental ambient air supply and HCT (with TWC overlayer fully covering the underlayer of zeolite HCT material).

FIG. 11 shows a Logic Flow Diagram for Air Injection During HC Trap Desorption Phase.

FIG. 12. shows a schematic depiction of the exhaust system tested.

### DETAILED DESCRIPTION

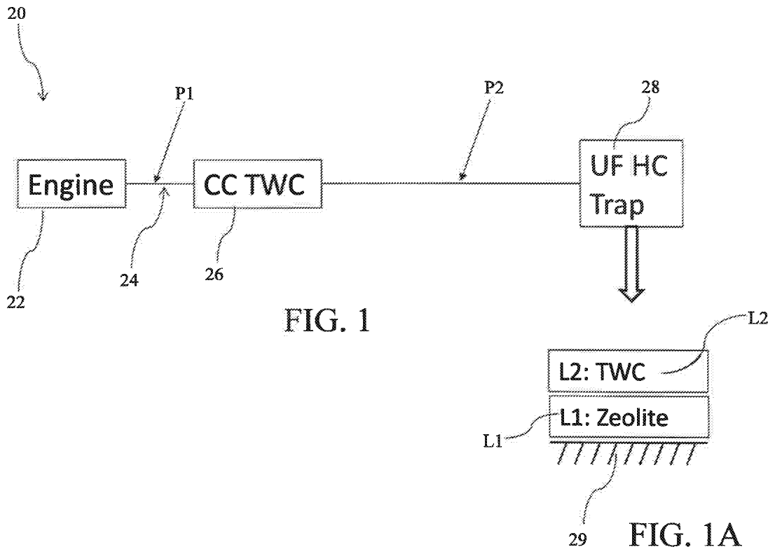

FIG. 1 shows a schematic view of a conventional exhaust gas after-treatment system 20 for the removal of pollutants from an engine's exhaust flow. An example of the system 20 is described in the background relative to the Chang reference, but can also be found in Heck et al. “Catalytic Air Pollution Control Commercial Technology” 3d Ed, 2009, Chapt. 6.11, Toward A Zero-Emission Stoichiometric Spark-Ignition Vehicle, pgs. 148 to 157, which article is incorporated by reference for background purposes. As seen in FIG. 1, system 20 includes a gasoline engine 22 that outputs exhaust gas to the catalyst system 24 comprising, in exhaust flow sequence, a close coupled three-way catalyst 26 and an under-floor hydrocarbon trap (uf-HCT) 28.

As described in the background, this approach is used to confront the issue of the lack of catalytic performance in the cc-TWC during cold start via the adsorption of hydrocarbons in the downstream uf-HCT. At light-off temperature the system reaches a temperature wherein previously stored hydrocarbons are released from the uf-HCT leading to increased pollutant output in the system.

With reference to FIG. 1A there can be seen that the uf-HCT features a catalytic TWC layer L2 used in an effort to oxidize the hydrocarbons upon desorption from the underlying zeolite HCT Layer L1. In other words, FIG. 1A shows a layering schematic for a catalyzed uf-HCT, featuring the noted two layer combination of underlayer L1 (zeolite-HCT) and overlayer L2 (TWC) supplied on a supporting substrate 29.

The two layer combination for the uf-HCT functions such that the HC's that are trapped in the zeolitic HCT during the engine cold start phase, are released in a desorption phase that occurs when the light-off temperature is reached at the uf-HCT. Thus, there is a desorption period that initiates at light-off (and continues until the HC's are released (provided desorption temperature levels are retained during this timeframe)) during which desorption period HC's desorb from the HC trap as a function of its temperature. The TWC overlayer in the uf-HCT is designed to help in the catalytic treatment of the desorbed HCs. However, in order for the desorbing HC's to be efficiently converted into H₂O and CO₂, oxygen availability is paramount.

With reference to FIG. 1, at reference point P1 in the exhaust line location (upstream of the cc-TWC and downstream from the engine), there can be a relatively high O₂ concentration in the engine-out exhaust at a time when the temperature is such that the uf-HCT is in a desorption state. Applicant has determined that despite the potentially high O₂ concentration at P1 (e.g., 5,000 to 10,000 ppm at engine out), the vast majority of engine-out exhaust oxygen content during the desorption phase is consumed by the reactions taking place in the upstream CC converter(s), resulting in a shortage of O₂ at reference point P2, which represents the level of oxygen availability reaching the uf-HCT (which as explained below can be essentially 0 ppm). Because of this, there is a lack of HC treatment at the uf-HCT despite the downstream uf-HCT being a catalyzed HCT with upper TWC layer. This lack of treatment leads to pollutant release and the inability to satisfy LEVIII standards absent, perhaps, a high quantity (overloading) of catalytic material in the TWC, as in a high quantity of expensive PGM materials such as Palladium and/or Platinum and/or Rhodium, for example. The lack of O₂ due to upstream removal by a TWCcc is but one example as to how there can be deficiencies in oxygen levels over the HCT at a time when desorption is ongoing. For example, any engine out lean spikes might also be captured/stored by an upstream TWC as a function of its oxygen storage capacity.

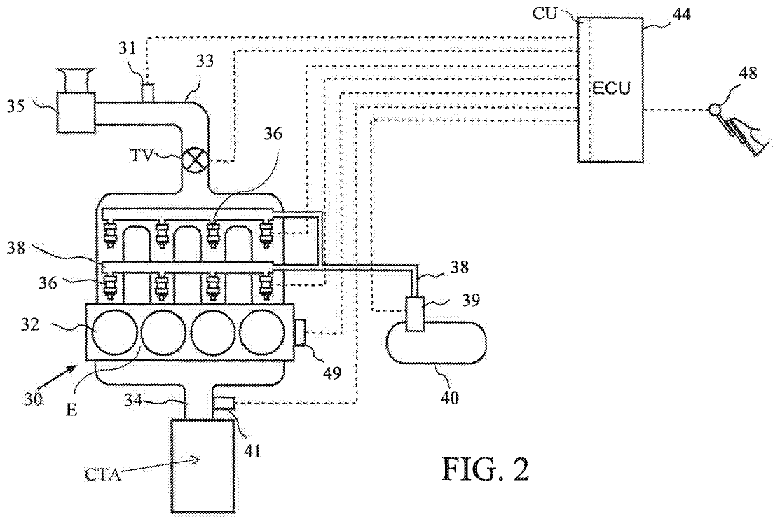

The present invention is directed at avoiding or alleviating at least some of these deficiencies associated with the conventional approaches to exhaust emission treatment. To facilitate an understanding of features under the present invention, an illustrative exhaust emission system 30 of the present invention is shown schematically in FIG. 2. As seen in FIG. 2, exhaust emission system 30 of the present invention includes internal combustion engine E to which the catalytic system or catalytic treatment apparatus (CTA) of the present invention is connected. The FIG. 2 example shown features a gasoline internal combustion engine E. The illustrated engine E can be utilized as a vehicle's sole major power source or can represent an engine provided with one or more additional major or primary power sources, as in a hybrid vehicle having an electric motor/fuel engine combination as the two primary power sources of the vehicle. The present invention is also well suited for use with vehicles having a “start-stop” system (or also referenced as a “stop-start” system) that automatically shuts down and restarts the internal combustion engine to reduce the amount of time the engine spends idling, thereby reducing fuel consumption and emissions. Such start-stop systems include ones found on non-hybrid vehicles as well as hybrid vehicles as each can benefit from the shut-down of an idling vehicle. Such start-stop systems receive sensed information based on sensor input to, for example, the vehicle engine control unit (ECU) whereupon a sensed idling vehicle can be shut down until operator activity suggests a desire to proceed again as in an accelerator pressing.

Thus, internal combustion engine E can take on a variety of forms (that can be benefited by the CTA of the present invention) with some examples including internal combustion engines that are operated with a predominantly stoichiometric air/fuel (A/F) mixture. Non-limiting examples include internal combustion gasoline engines as in port-fuel injection (PFI) engines, stratified charge engines (SCE), and gasoline direct engines (GDI). Additional examples of gasoline combustion engines suited for present invention exhaust treatment apparatus emission reduction include dual injection system engines (i.e., PFI+GDI) and gasoline direct injection compression ignition engines (GDCI), which GDCI's operate cold and have extremely delayed light off (illustrating how the various zones described below as in adsorption, desorption, and air injection can vary as to require the exhaust emission system 30 to be adjusted to suit the desorption period for the uf-HCT (e.g., control unit signal timing as in one based on modeled uf-HCT temperature) to better accommodate for such variations). These types of gasoline engines run predominately at stoichiometric air/fuel mixtures, but also typically have their air/fuel ratios finely calibrated in accordance with sensed operating conditions. This calibration includes, in general terms, toggling between slightly rich and slightly lean depending on the current needs and limitations (e.g., a λ toggling such as 0.97 to 1.03) inclusive of togging between extended periods of stoichiometric running. The aforementioned GDCI engines, as an example, operate lean at light and medium loads, and stoichiometric at high loads. It is also noted that the amplitude for such rich/lean toggle cycling generally is a function of engine load in most cases, and thus varies. Most modern lambda calibrations also shut off the injectors during the aforementioned deceleration phases (i.e., Deceleration Fuel Cut Off, “DFCO”).

As one example of an engine of the present invention, engine E in FIG. 2 is shown as a spark-ignition internal combustion engine having a plurality of cylinders 32. While the internal combustion engine shown in FIG. 2 has four cylinders 32, the number of the cylinders may be three or less or five or more (e.g., 1, 2, 4, 6, 8 or 12 as engine examples featured in the present invention). Also, while engine E is shown as a sole main power source of the vehicle in FIG. 2, it can also represent a second main engine source used together with another main power source as in a hybrid's electric motor. As shown in FIG. 2, internal combustion engine E is connected with an air intake passage 33 and an exhaust passage 34. The intake passage 33 is a passage used to deliver fresh (typically ambient) air taken from the atmosphere to the cylinders 32 of the internal combustion engine E. The intake passage 33 is provided with an air cleaner 35. The intake passage 33 is further provided with an air flow meter 31 at a location downstream of the air cleaner 35. The air flow meter 31 outputs an electrical signal correlating with the quantity (or mass) of air flowing in the intake passage 33, which electrical signal is received by engine control unit 44 (ECU's can use other inputs such as air pressure and air temperature to calculate intake air mass flow rate using the ideal gas laws PV=mRT). The intake passage 33 is provided with a throttle valve TV at a location downstream of the air flow meter 31. The throttle valve TV is in control communication with ECU 44 and varies the quantity of air supplied to the internal combustion engine E by varying the channel cross sectional area of the intake passage 33 as per instructions from the ECU.

The intake passage 33 downstream of the throttle valve TV forks into four branch pipes, which are connected to the cylinders 32, respectively. To each branch pipe of the intake passage 33 are attached a row of fuel injection valves 36 injecting fuel (e.g., gasoline, with or without supplements such as ethanol) into the respective cylinders. Fuel injection valves 36 are in fluid communication with fuel delivery pipe 38, which is in line with fuel pump 39 sourcing from fuel tank 40.

The gasoline stored in fuel tank 40 is supplied to the fuel delivery pipe 38 via the fuel pump 39, and then distributed to the four first fuel injection valves 36 from the fuel delivery pipe 38. A shown the respective fuel valves are in flow control communication with ECU 44, as is fuel pump 39. In other words, fuel pump 39 pumps the gasoline drawn from tank 40 for injection into the respective cylinders (with the injection valves 36 being schematically shown, as their outputs can be at different locations relative to the cylinders 32 and the respective cylinder in-feeds, as determined by the type of engine (e.g., GDI or PFI)).

The exhaust passage 34 is a passage used to cause burned gas (exhaust gas) discharged from the cylinders 32 to be emitted to the atmosphere after passing through exhaust gas purification device or exhaust treatment apparatus (CTA) of the present invention. Sensor apparatus 41 (typically one or many sensors of the same or different types used to monitor CTA status and at potentially multiple positions in the exhaust passage) is generically represented in this embodiment. Sensor apparatus 41 is preferably inclusive of an air/fuel equivalence ratio or A/F sensing means that, for example, outputs an electrical signal, correlating with the air-fuel ratio of the measured region of the exhaust passage 34, to ECU 44. For example, the A/F sensor outputs an electrical signal for determining the current λ, value in the exhaust, and can take on a variety of sensing means such as an oxygen sensor with associated voltage meter and can be positioned at one or more strategic positions relative to the exhaust passageway leading from the engine outlet to an exhaust conduit outlet to the environment.

As some examples of suitable sensors for use in sensor apparatus 41, reference is made to UEGO's Universal Exhaust Gas Oxygen sensor (a.k.a. LSU) and HEGOs Heated Exhaust Gas Oxygen sensor (a.k.a. LSF). A UEGO or HEGO may be present in the engine out or pre-catalyst position. HEGOs output a voltage (0-1V) and are designed mainly to indicate whether an engine system is operating rich or lean of stoichiometric, but are also capable of measuring air fuel ratios (AFR) very close to stoichiometric at a high resolution. One type of UEGO outputs varying current (based on varying internal resistance), which helps correlate with an exact lambda. The upstream UEGO or HEGO can be used as the main control feedback, in many cases. HEGOs are often present in the catalyst downstream position and are used for catalyst monitoring and very fine fueling adjustments (i.e., fuel trim). Usage of either or both of UEGO sensor(s) and HEGO sensor(s) are featured in embodiments of sensor apparatus 41.

An air-fuel ratio (AFR) is the ratio between the mass of air (Mₐᵢᵣ) and mass of fuel (M_{fuel}) in the fuel-mix at any given moment. That is: (AFR=Mₐᵢᵣ/M_{fuel}). The mass is the mass of all constituents that compose the fuel and air whether combustible or not. Reference is also made in the art to the “lambda value” (λ-lambda) which is the ratio of actual AFR to stoichiometry AFR (AFRactual/AFRstochio) for a given mixture. Thus, λ=1.0 is at stoichiometry, rich mixtures λ<1.0, and lean mixtures λ>1.0.

FIG. 2 further illustrates internal combustion engine E in control communication with electronic control unit ECU 44. ECU 44 is configured to receive present data as in sensor data inputs and adjust system 30 operation (e.g., fuel injection) to have the engine E run in a desired present mode. ECU 44 is shown in this example as an electronic control unit composed of, for example, a CPU, a ROM, a RAM, and a backup RAM, etc. As shown by the small dashed lines in FIG. 2, ECU 44 is preferably electrically connected with various sensors such as an accelerator position sensor 48, crank position sensor 49, air flow meter 31, etc. The accelerator pedal position sensor 48 is a sensor that outputs an electrical signal correlating with the position of the accelerator pedal (accelerator opening degree). The crank position sensor 49 is a sensor that outputs an electrical signal correlating with the rotational position of the crankshaft of the internal combustion engine E.

ECU 44 controls the above-mentioned various components based on signal outputs from the above-mentioned various sensors. The ECU 44 is, in the illustrated embodiment, designed to control the relative on/off and duration states of the fuel injection valves 36 such that there is provided for independent control as to which injector(s) 36 are feeding fuel into the cylinders and which injector(s) 36 are not, as well as the length of time of such respective fuel feed(s), which enables a calibrated approach to the overall air/fuel ratio under which the engine is operating at any given time as well as controlling the primary air injection source to the vehicle as to also provide for some control as to the oxygen content in the “exhaust-out” from the engine E as determined by the primary air (oxygen) supply apparatus.

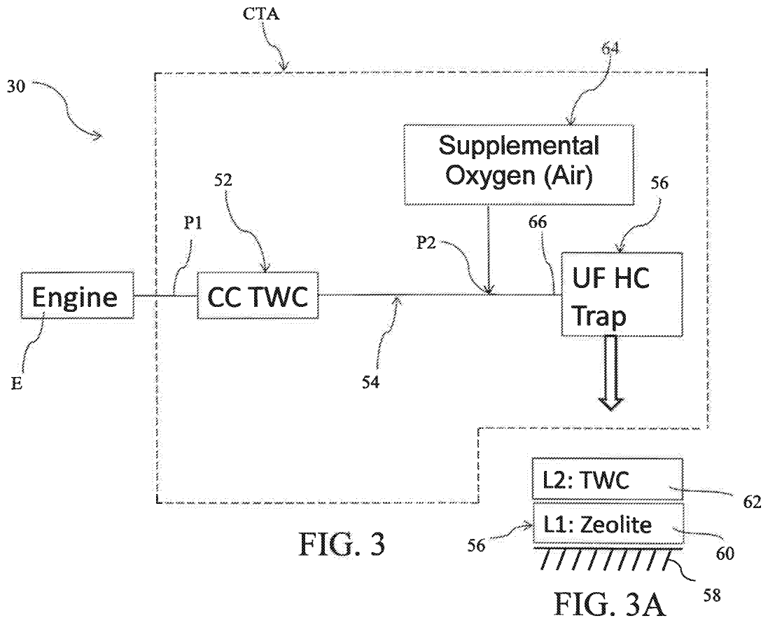

At least some of the above described sensors, inputting to the ECU traditionally, play a role in engine-out oxygen level adjustments such as the above described engine control programs to enhance emission system efficiency (e.g. lean/rich toggling in a predominately stoichiometric gasoline running engine). As explained in greater detail below, the FIG. 2 control unit CU (or sub-control unit of ECU) is designed, in the illustrated embodiment, to strategically work with the supplemental oxygen input means (e.g., see the below described secondary oxygen provider 64 shown in FIG. 3, which is shown as secondary in the illustrated embodiment in light of the above noted standard primary oxygen (air) feed from the air intake assembly of the vehicle). The supplemental or secondary oxygen supply means of the present invention provides a lean state (e.g., a mass flow rate of injected air (as from a pump source) into the exhaust passing over the desorbing uf-HCT of 1 to 30 L/s (with 5 to 20 L/s as well as 10 (+/−2.5) L/s being well suited for some system arrangements). It is noted that specifying lambda is difficult, because the source of excess oxygen (as in an air pump) can be running during an engine fuel shut off, when there is no fuel being injected. During this point a designation of lambda is difficult to define because the air to fuel ratio during a fuel cut is undefined (cannot divide by sensed 0). Therefore, reference is made here to supplemental air injection in terms of its mass flow rate of air into the exhaust. However, it is noted that when lambda is definable, there is a lean lambda range of, for example, 1.1 to 3.0 (or 1.2 to 2.0) in the exhaust reaching the upstream end of the uf-HCT, and preferably, in the exhaust traveling over the HCT during a time period of HC desorption from the hydrocarbon trap of the CTA (e.g., providing a lean lambda to facilitate the oxidation of HCs that are on, for example, a TWC layer over the uf-HCT (and/or on the uf-HCT itself)).

FIG. 2 shows an embodiment of the invention featuring control unit CU (which is a controller that is designed for use with the CTA of the present invention and is comprised of, for example, a CPU, a ROM, a RAM, and a backup RAM, etc., which components of the CU can be shared or independent components relative to ECU 44). Thus, in the embodiment of FIG. 2, control unit CU is depicted as a sub-part of the ECU 44. The illustrated CU, as a sub-part of ECU 44, provides the advantage of being able to utilize sensor inputs being feed to the ECU 44 that are also pertinent in conjunction with the CU providing a strategic lean running period via the supplemental oxygen relative to the CTA during the aforementioned desorption of an HC-trap; following, for example, cold start adsorption of HCs by that HC-trap or HCT.

The control unit CU is designed on the basis of a determination that the HC emission reduction for an HCT (in the CTA) used to adsorb cold start HCs and located in an UB exhaust position is highly dependent upon the availability of oxygen during the HC desorption phase. In other words, in order for the desorbing HC's to be efficiently converted into H₂O and CO₂, oxygen must be available for oxidation. However, for typical modern calibrated vehicles, lean operation (if present) after initial startup is short and does not extend into the HC desorption phase of the HC trap. It is noted that for many current HC trap technologies , that are suitable for use in the present invention, desorption begins at 200° C. based on inlet bed temperature for the HC trap and is complete when the inlet bed reaches 450° C.

By the time of HC desorption, (e.g., initiating 50-150 seconds into the FTP test), the calibration on the vehicle is either at or close to stoichiometry and/or all oxygen has been essentially consumed by the combustion of HCs and CO over the close-coupled catalysts and/or trapped by the TWC. In the absence of the features of the present invention, this results in no or too little oxygen being available during the rapid release of HCs during HC desorption phase from the HC-trap. This lack of oxygen is problematic even with higher temperatures having been reached in the system, as proper HC conversion is not possible due to the lack of oxygen despite the typically well suited higher temperature level for such reactions.

FIG. 3 shows a schematic view of a first configuration of exhaust emission system 30 of the present invention which is comprised of internal combustion engine E to which the catalytic system or catalytic treatment apparatus (CTA) of the present invention is connected (the control means and fuel supply source not being shown in this schematic depiction).

FIG. 3A shows the layered configuration of the catalyzed uf-HCT in FIG. 3, which is illustrative of a preferred embodiment of the invention although other arrangements such as those described below are featured. Thus, FIG. 3A shows a catalyzed uf-HCT with the catalyzation being provided by a catalytic layer integrated (e.g., a covering layer shown, although various comingling and dispersion arrangements are featured under the present invention). However, there is also considered, in some HCT and TWC relative compositions, to be the potential for a negative interaction between the HCT and TWC material/layers as material in the HCT (e.g., silica) can poison the TWC function in the TWC layer. Also, typically the HCT washcoat (“WC”) layer is soft and there is likely to be some intermixing of the two layers when coating. As such, an intermixing can be bad for TWC performance, it is thus preferable in some embodiments if the TWC, when present in the HCT, has Rh, as Rh is considered to be the most resistant PGM to negative interaction with HCT poisoning material (such as silica (when present)) in the HCT layer, and which, if allowed, degrades TWC performance. Thus, under preferred embodiments, when a TWC is a component of the underbody HCT, it includes PGMs of Rh only or Rh and Pd.

In any event, it is generally beneficial to have a catalyzing layer above the HCT material as it is located directly at the desorption location of the HCT. The catalyzing layer is designed to help promote the oxidation of released HC's previously trapped by the HCT while also preferably being effective relative to the other exhaust pollutants passing across the HCT. A preferred catalyst material for this purpose is a TWC or an oxidation catalyst material, with the former being well suited for treatment of each of the HC, CO and NOx pollutants, the latter (OC) being well suited for HC and CO oxidation (with the NOx being preferably treated under embodiments of the invention with, for example, an SCR catalyst and/or nitrogen storage catalyst (NSC)), although it is noted that with the supplemental oxygen supply apparatus of the present invention, there is the ability not to run the engine lean during the desorption period, which helps avoid engine out generation of NOx such that there is less concern in this regard for slippage of NOx past the uf-HCT (one of the benefits of the present invention compared to other systems).

Also, while one uf-HCT is shown with common supported TWC as an outer layer, alternative embodiments include placing downstream from the uf-HCT (with or without an incorporated HC or OC layer) a downstream catalyst to compensate for any slippage of pollutants past the uf-HCT, particularly at the time of desorption, as in an oxidation slip catalyst (e.g., one with a Pd band or zone addition). Alternatively, and more preferably in some situations, there is provided a high Pd zone at the outlet of the HC trap as to minimize any increase in thermal inertia and to have the oxidation function as part of the trap monolith (a separate brick after the HC trap can be cold—and thus may not add much to HC oxidation at pertinent times).

Examples of various suitable combinations relative to a catalyst having HCT and NOx-trap components as well as, optionally, TWC component(s) [e.g., various layers and zoning, and barrier layering, and either common substrate support or multiple substrate support, etc.], are described in co-pending U.S. application Ser. No. ______ having a reference identifier as 034166.287 and a common filing date with the present application and entitled “EXHAUST EMISSION REDUCTION SYSTEM HAVING AN HC TRAP AND NOX TRAP COMBINATION DESIGNED FOR OPERATING UNDER STRATEGIC LEAN CONDITIONS”. This co-pending US application is incorporated herein by reference in its entirety (although this incorporation by reference is not intended to imply, in the present application, any form of licensing in the referenced co-pending application as is true with respect to any other commonly owned incorporated reference herein).

As noted above, an additional embodiment of the invention can include a high concentration PGM band (preferably a Pd band) of a less than half carrier length such as a 2-3 cm long PGM layering at the outlet of the HCT applied by using a PGM (e.g., Pd) solution dip. In this way there is added PGM (e.g., Pd) at a strategic location without adding extra WC (increased thermal inertia) and via this arrangement there is the potential to oxidize the HCs before they permanently leave the HCT).

For purposes of the present application, the terminology “close-coupled (cc) position” is one that is close to the engine outlet, as in the initial contact of the close-coupled catalyst system device being at or within and up to 30 cm from engine outlet (based on exhaust pipe length), and more preferably in some situations being at or within 25 cm from the engine outlet to the component's inlet. Many embodiments of the present invention include CC converters at or within about 20 cm from the engine (e.g., a converter of 10 cm long with an inlet at 20 cm would have its downstream end at 30 cm, which downstream end can then be used to determine the distance to the upstream end of the one or more UB catalysts).

Also, the reference to “underbody” (UB) position in the present case is in reference to a farther downstream location (beyond the downstream end of the last determined CC positioned catalyst) as to provide, for example, a location away from the engine and under the cabin floor of the vehicle with the engine emitting exhaust. The under body spacing should be sufficient to ensure the maximum exhaust temperatures do not surpass the degradation temperature of the underbody HCT component. For example, the temperature the HCT will experience at a given distance varies with vehicle type. In preferred embodiments the underbody HCT component should not see normal temperatures above 750° C. and the maximum continuous operation is 800° C. with some spikes to <850° C. Higher heat temperature embodiments for the underbody HCT component are, however, featured under the present invention. Also, examples of suitable spacing of CC positioned CTA components and downstream underbody HCT components include, for example, a distance range of 50 to 100 cm (CC outlet-to-UB HCT inlet). However, distances from the engine and between CC component and UB HCT components are primarily dictated by the temperature along the exhaust passageway.

A CC range of 0-30 cm (to inlet of CC component from exhaust manifold outlet) and 80 to 130 cm (from the exhaust manifold outlet to the inlet of the HCT) represent suitable distances under many embodiments of the invention.

Under embodiments of the present invention having the HCT farther downstream (e.g., the higher half of the above noted 80 to 130 cm range (when practical) can be advantageous, as having the HCT farther downstream slows down the light off and can result in more exposure time of desorbing HCs to O₂).

For purposes of some systems under the present invention, there is preferred a CC temperature range of 600 to 1000° C., and an underfloor component temperature range of 350 to 700° C.

As further shown in FIG. 3, engine E feeds to the CTA of the present invention which, in the illustrated embodiment, is inclusive of a close coupled system 52, comprising, for example, one or more (e.g., TWC) catalyst regions (e.g., one TWC, or more than one TWC, each with independent supporting substrates, or multiple different TWC zones (e.g., different loading amounts and/or the catalytic make up) on a common substrate. As noted above TWC system 52 is positioned in a close coupled region relative to the exhaust line 54 of the CTA . Embodiments of the present invention also feature the use of a cc-HCT (a second HCT in the overall system) that is alone, or upstream, or downstream from the cc-TWC (or other cc-catalyst) if present.

FIG. 3 further shows a catalyzed uf-HCT 56 positioned downstream (e.g., an underfloor position that places the inlet of the uf-HCT at a distance from the engine output which meets the above described UB criteria. Moreover, uf-HCT 56 has a layered arrangement as shown in FIG. 3A featuring a supporting body 58 (e.g., a honeycomb support structure) with an HCT coating layer 60 over the support 58 and lying under the over-covering TWC layer 62 (preferably with a platinum group metal or PGM of or involving Rh). Such platinum group metals (also precious group metals) are traditionally described as including the elements Ir, Os, Pd, Pt, Rh, Ru, although for most applications one or more of Pd, Pt, Rh are utilized (as further described herein).

FIG. 3 also includes (reference only) point P1 which, as described above, is a region where an engine-out oxygen amount can be sufficient for the TWC operation at cc-TWC 52, but has been found by the Applicant to result in a deficient amount of oxygen at the uf-HCT to properly remove (e.g., relative to LEVIII standards) pollutants (e.g., summed NMOG (or NMHC) plus NOx amounts exceeding LEVIII maximum levels allowed). Under the present invention point P2 (again reference only) represents a location downstream of cc-TWC 52, and upstream of uf-HCT 56, which is a location in the prior art systems where there is often found deficient oxygen to reach suitable reaction levels relative to the released HCs at the uf-HCT at the current temperature of the uf-HCT 56.

FIG. 3 further schematically shows supplemental oxygen supply means 64 (or supplemental oxygen supply apparatus 64), which in the FIG. 3 embodiment is shown as supplying added oxygen to the system, as by ambient air injection. The supplemental oxygen supply means 64 is shown with an exhaust line 54 air injection location that is between the outlet of cc-TWC 52 and the inlet of uf-HCT 56. The supplemental oxygen injection point location along this intermediate portion of exhaust passageway 54 is designed to provide a sufficient quantity of dispersed oxygen at the uf-HCT to offset the prior art oxygen deficiency during HC desorption. Thus, in some systems there is a preference for an injection point for supplemental oxygen to be closer (along the exhaust passageway 54) to uf-HCT 56 than to cc-TWC 52, and also preferably close to or at the upstream end of the uf-HCT to provide the desired source of oxygen to the HC's desorbing from the uf-HCT.

An example of a suitable injection point or points upstream of uf-HCT 56 is an amount less than 10 cm away from the initial contact region of the uf-HCT, as in direct injection into the exhaust flow of the exhaust conduit leading to the uf-HCT. Although less desirable from the standpoint of oxygen mixing within the exhaust stream before uf-HCT contact, an alternate supplemental oxygen injection location is one that injects directly into the uf-HCT (a radial axis of injection that intercepts the uf-HCT or a canister receiving the uf-HCT). Air supply by injection or supplying supplemental oxygen right at the inlet region 66 of the uf-HCT (inclusive of injection into a canister or the like in which uf-HCT 56 is contained) is another option, but also has the above noted dispersion limitation. In addition, a dispenser system (e.g., tangential injector and/or mixing fins) to intermix incoming supplemental oxygen with the traveling engine exhaust can also be included in the exhaust line leading to the uf-HCT or the canister of the uf-HCT.

As explained in greater detail below, the oxygen supplementation is designed to provide a sufficient oxygen amount at the uf-HCT location as to enable removal of pollutants at that location inclusive of the released HCs previously adsorbed by the HCT such as during the cold start region preceding obtainment of the light-off temperature. The amount of oxygen injected can be varied depending on system parameters, but preferably is set as to provide, for example, a mass flow rate of injected air (as from a pump source) into the exhaust that is about to pass over the uf-HCT of 1 to 30 L/s (with 5 to 20 L/s as well as 10 (+/−2.5) L/s being well suited for some system arrangements). When there is not a fuel cut disruption and lambda is determinable, a high lean environment generated over the desorbing uf-HCT as in a λ value of 1.2 to 3.0 upon initial contact with the uf-HCT is desirable in some embodiments. Furthermore, in embodiments utilizing ambient air which is cooler than exhaust gas temperatures, the flow of supplemental oxygen (e.g., ambient air) can provide a cooling effect on the HCT bed. It is further noted that a lean exhaust environment is best for HC and CO oxidation, but bad for NOx. The mechanism by which NOx would be created across the HCT would be ammonia (NH₃) oxidation. However, during the timeframe under which the CU focuses on (as in just after a cold start with a focus on providing supplemental oxygen during HC desorption), there is very little NH₃ being made across the upstream CC, so the benefits of HC and CO reduction under the present invention arrangement/approach outweighs the concern of NOx slippage (e.g., a modulated AFR around stoichiometric is best for controlling HC, CO and NOx across a TWC, but during the pertinent time period there is more of a focus on HC's, so the referenced supplemented lean exhaust flow over the desorbing HCT is beneficial). Also, in an embodiment of the invention there can be further utilized an upstream TWC to help handle the engine out NOx emissions during the pertinent desorption period (see also the discussion above about the low output NOx benefits through enablement of stoichiometric or rich flow at the engine out location during the desorption period under embodiments of the present invention).

As described above, FIG. 3A shows an example of uf-HCT 56 as a catalyzed HCT comprising a supporting substrate 58, an intermediate HCs trapping material layer 60, such as a zeolite or zeotype material layer, and an overlayer 62 (direct or over an additional intermediate layer). Preferred loadings for the FIG. 3A trap combination include 2.0-2.5 g/in³ for the TWC layer and a HC-trap layer loading of at least 3.0 g/in³, preferably higher at 3.5 g/in³. Some of the suitable material for each of these uf-HCT components are described above and below. As an example of an intermediate layer there can be provided a barrier layer, as in a thin layer of gamma alumina, to help avoid TWC degradation due to contact with degrading material present in the HCT as in Si, if present, as well as base metal migration (e.g., Fe) from the catalyzed HCT to the TWC.

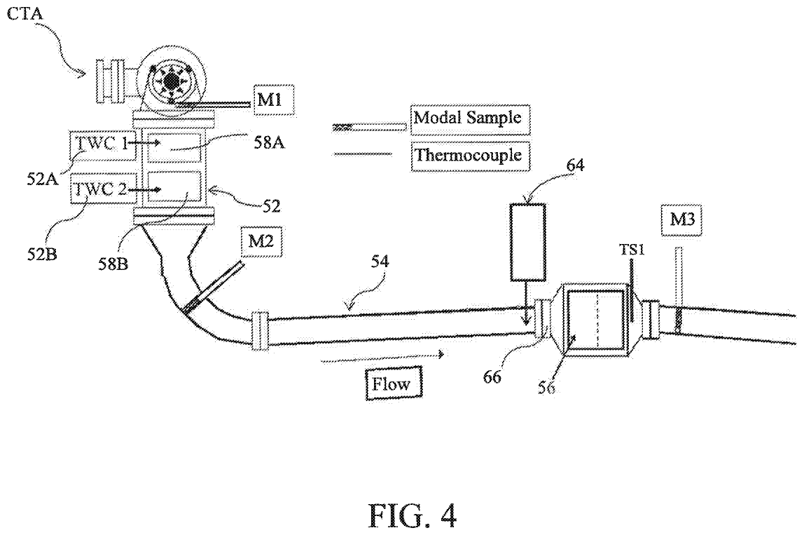

FIG. 4 shows one potential example of a configuration for the Catalytic Treatment Apparatus (CTA) of the present invention, and which is shown schematically (generically) in FIG. 3. As shown in greater detail in FIG. 4, close coupled TWC system 52 comprises one or more TWC's in close coupled position. In the FIG. 4 example, there is illustrated two TWC's 52A and 52B supported on respective substrate supports 58A and 58B (see substrate support 58 in FIG. 3A) that are within a common canister or exhaust pipe length at the close coupled position.

As an example of an alternate CC set up, substrate 58A can support a TWC and 58B an OC (or vice versa) or a cc-HCT can replace either one of the TWCs shown. FIG. 4 also shows sensor systems which are illustrative of the generically presented sensor system 41 for use with the CTA in general (with modal sensors M1 to M3 and thermocouple temperature sensor TS1 shown). Modal sensors M1 and M2 can be oxygen sensors for lambda determinations, which are already commonly found on most production gasoline engine vehicles in the noted positions upstream and downstream of the TWC system 52. Modal sensor M3, shown downstream from the uf-HCT, is an added component for supplying information to the CU (and/or ECU) relative to, for example, the downstream lambda value exiting the uf-HCT. Sensor M3 is preferably coupled with a temperature sensor Ts1 (as in a thermocouple) to monitor pertinent temperatures as in the outlet exhaust temperature of the uf-HCT (e.g., a determination of the outlet bed or exhaust gas T facilitates a determination of when the HCs desorb). Thus, with the inclusion of M3 and/or Ts1 there is provided information to the CU which is informative of the desorption level of the uf-HCT which information is helpful relative to timely shutting down the supplemental oxygen supply over the HCT and returning to the normal predominately stoichiometric calibration of the engine as well as determining initiation of supplementation. In an alternative embodiment either or both of M3 and Ts1 (as well as M1 and M2) can be dispensed with and reliance placed on empirical modeling as to the presumed end of desorption (as in a comparison of engine run time under supplemental oxygen supply mode for removal of the desorbing cold start HC load, for example). For instance, empirical modeling can use modeled uf-HCT temperature expectations as for initiation and/or termination of supplemental oxygen supply.

The referenced modal sensors M1, M2 and M3 represent sensors suited for sensor system 41 and can include oxygen sensors as in the above noted UEGO and HEGO sensors. Thus, these sensors are representative of sensors that can be used to provide status information to the CU (and/or ECU) to enable monitoring various attributes of the exhaust emission system 30 shown in FIG. 2. Thus, the various M1 to M3 modal sensors and the temperature sensor TS1 represent an example of a sensor set up which is only generically represented as sensor system 41 in FIG. 2. Insofar as the CU received data, as the lambda value sensing by the lambda sensors (e.g. HEGO and/or UEGO sensors) is highly informative, these can be relied upon alone by the CU (although preferably the CU also works in conjunction with temperature sensor(s) particularly the outlet bed temperature of the HCT). Furthermore, the depicted temperature sensor Ts1 at the outlet bed of the uf-HCT is additionally informative of CTA system status relative to when desorption is initialized, ongoing or complete in that the HCT acts like a chromatographic column. That is, as HCs are desorbed from the hotter front of the uf-HCT brick only to re-adsorb in the cooler rear sections until the rear is sufficiently hot enough to desorb them completely. Accordingly, a highly informative temperature (if utilized—as in if not used due to CU reliance on modeling only) for the control unit CU is the outlet bed temperature which Ts1 is informative thereto. The use of different modal sensors or other temperature sensors (with or without the temperature sensor at the outlet region of the uf-HCT) can be relied upon, as in extrapolation from other temperature locations, further computer modeling, etc. Further, as explained in the discussion below relative to CU operation/configuration, various other sensors can be monitored (e.g., battery level which is also typically an ECU sensed parameter) relative to operation of the supplemental oxygen supply apparatus.

Also, the FIG. 4 CTA presentation shows an exhaust line that, while having curved regions, is free of a looped region from engine outlet to environment outlet, which is illustrative of a preferred exhaust conduit set up that is well suited for usage under the supplemental oxygen supply means arrangement of the present invention. Also, the TWC(s) shown can be either of a common design or different as in a higher catalyst loading on the upstream cc-TWC 52A and a lower catalyst loading on the downstream cc-TWC 52B (again the present invention is inclusive of a single cc-TWC 52 as in having only cc-TWC 52A). Also, as seen from the discussion below, the uf-HCT can be a catalyzed HCT inclusive of TWC catalyzed HCT embodiments such as featured in FIG. 3A, with the TWC material either being one and the same as that used upstream in either of the TWCcc locations, or a different TWC material well suited for the farther downstream location.

### Supporting Substrate

Substrate supports on which the catalyst material and/or HCT material are supported (e.g., a substrate support suited for receiving a washcoat loading of the catalyst material and/or HCT material) include a flow through or wall-flow honeycomb body, or the supporting substrate may take on a number of different forms, including, for example, one or more corrugated sheets; a mass of fibers or open-cell foam; a volume of porous particle bodies; and other filter-like structures. Also, if a honeycomb body is utilized it may be made of suitable heat-resistant materials such as metal and/or ceramic materials. Preferably, the supporting substrate, when in honeycomb body form, is composed of: cordierite, cordierite-alumina, silicon nitride, mullite, zircon mullite, spodumene, alumina-silica magnesia, zircon silicate, sillimanite, a magnesium silicate, zircon, petalite, alpha-alumina, an aluminosilicate, silicon carbide (SiC), aluminum titanate, or the like, and combinations thereof. Suitable embodiments of the invention include the supporting substrate described above on which the catalyst material can be supported as by having PGM metals supported on suitable (e.g., metal oxide) support carriers (carrier support materials) which are applied in washcoat fashion on to the supporting substrate 58.

The aforementioned supporting substrate types are equally applicable to upstream cc-catalysts and can be the same or different than supporting substrates 58, with preference for higher temperature resistance compositions in recognition of the cc position's higher temperature.

### TWC Washcoat (e.g., Carrier Material and Catalyst Material)

According to aspects of the present invention wherein there is an upstream cc-TWC substrate and/or TWC layer on the downstream catalyzed HC-trap, each catalyst zone (cc and uf) is preferably prepared by coating a substrate support such as substrate support 58 with an appropriate washcoat carrying a catalyst such as one comprising three-way functionality. The composites can be readily prepared by processes well known in the prior art. As used herein, the term “washcoat” has its usual meaning in the art of a thin, adherent coating of a catalytic or other material applied to a substrate carrier material (e.g., metal oxide carrier) with both the catalytic material and carrier material supplied on the above described supporting substrate such as a honeycomb-type support substrate, which is sufficiently open to permit the passage there through of the gas stream being treated (e.g., a flow-through monolith). The scope of the present invention is also inclusive of “additional” underfloor components, as in a gasoline particle filter positioned upstream of the uf-HCT (although the uf-HCT can alternatively, itself, be in the form of a gasoline particle filter (e.g., a gasoline particle filter with a washcoat of HCT with or without an added TWC coating)). However, even with the presentment of such “additional” underfloor catalyst components, the inclusion of the present invention's controlled, supplemental oxygen supply method/apparatus is considered a requirement based on the notion that there is lacking sufficient oxygen during the described desorption period, which the supplemental oxygen supply method/apparatus of the present invention remedies.

The particle component of the washcoat of the present invention are preferably sized for soaking into the porous surface of the supporting substrate at least partially, although alternative embodiments include also overcoating the porous body of the supporting substrate so as to have dried washcoat bridge the porous opening of the supporting substrate and a combination of both (e.g., via different carrier particle size ranges). Preferred embodiments of support substrates for receiving the washcoats (“WC”) include highly porous flow through substrates with porosities of 55-65%. As described above, the TWC layer loading can be 2.0-2.5 g/in³, and the HC-trap layer loading is preferably up to at 3.5 g/in³. This gives a very high WC load overall and suitable pressure drop levels across the supporting substrate. With the preferred relatively high porous substrates noted, nearly all the first pass of the trap layer (e.g., 1.5-2.0 g/in³) flow into the wall of the relatively high porous substrate. This facilitates the preferred high WC loading at acceptable pressure drop levels. It is further noted that the zeolite particle sizes, that are typically small (e.g., at <2 microns in diameter) facilitate allowing WC into the relatively high porous supporting substrate.

In principle, and within the limits of the present invention, suitable TWC washcoats can be utilized in the treatment system, provided they provide effective treatment of gasoline engine exhaust gas. As noted above TWC operate most efficiently with exhaust gas falling at or close to λ=1. A discussion of suitable TWC washcoats and their application in zoned, single layer or multilayer design can be found e.g. in EP1974810B1, PCT/EP2011/070541, EP1974809B1, or PCT/EP2011/070539 (each incorporated by reference for background disclosure purposes). A discussion of a cc-TWC in use, with downstream uf-HCT, can also be found in US 2016/0245207, which is also incorporated by reference.

Aspects of the present invention include the TWC washcoat as comprising a catalyst composed out of PGM metals on a carrier support material as in a metal oxide carrier support material. The carrier support material is preferably selected from the group consisting of alumina, zirconia, zirconia-alumina, barium oxide-alumina, lanthana-alumina, lanthana-zirconia-alumina, and mixtures thereof. The metal oxide carrier support material of gamma-alumina is well suited for many present invention usages. Aspects of the present invention further include the carrier support material being doped with a rare-earth, alkaline earth or refractory metal oxide in an amount preferably ranging from 0.01 to 30 wt.-%, more preferably from 0.05 to 15 wt.-%, even more preferably from 0.1 to 10 wt.-%. In particular, the rare-earth, alkaline earth or refractory metal oxide is preferably selected from the group consisting of ceria, lanthana, praseodymia, neodymia, barium oxide, strontium oxide, zirconia and mixtures thereof, wherein the rare-earth, alkaline earth or refractory metal oxide is preferably lanthana, barium oxide and/or zirconia. One aspect of the present invention features the metal oxide carrier support material as gamma-alumina which is optionally doped with a rare-earth, alkaline earth or refractory metal oxide, more preferably with lanthana, barium oxide and/or zirconia. The incorporation of the PGM with the support material can be carried out in any of the known techniques in the art. For example, dispersion techniques to disperse metals on support oxides in order to obtain maximum catalytic function at the minimal concentration of applied transition metals involve, for example, impregnation, precipitation, ion exchange, etc., of the transition metal salt on to the desired support oxide. The present TWC material can also be provided to the carrier support material as by a solventless, dry loading technique such as that featured in US 2014/0112849 published Apr. 24, 2014 and assigned to Umicore AG (and which reference is incorporated herein for background disclosure purposes).

In addition to said (e.g., metal oxide) carrier support material, the TWC washcoat of the cc-TWC can comprise an oxygen storage component (OSC). Oxygen storage materials have redox properties and can react with oxidizing components such as oxygen or nitrogen oxides in an oxidizing atmosphere and with reducing components such as hydrogen or carbon monoxide in a reducing atmosphere. These oxygen-storing materials are often doped with noble metals such as Pd, Rh and/or Pt, whereby the storage capacity and storage characteristic can be modified. The upstream TWC can make use of OSC with released oxygen lessening the degree of engine out oxygen levels which can lead to poorer engine performance under some running conditions. The downstream TWC layer on the uf-HCT can also be provided with OSC, although supplemental oxygen sourced from supplemental oxygen supply means 64 can be accurately controlled and lowers the need or impact of such OSC loading material.

If utilized, oxygen-storing materials are usually composed of oxides of cerium and are possibly used with other metal oxides as thermally stable mixed phases (for example Ce/Zr mixed oxides), preferably chosen from the group consisting of ceria-zirconia-, ceria-zirconia-lanthana-, ceria-zirconia-neodymia-, ceria-zirconia-praseodymia, ceria-zirconia-yttria-, ceria-zirconia-lantha naneodymia-, ceria-zirconia-lanthana-praseodymia- or ceria-zirconia-lanthana-yttria-mixtures. These are capable of removing oxygen from the exhaust gas under lean conditions and releasing said exhaust gas again under rich exhaust-gas conditions. In this way, it is prevented that, during the brief deviation of the fuel/air ratio from λ=1 into the lean range during AFR toggling by the ECU, the NOx conversion across the TWC decreases and NOx breakthroughs occur. Furthermore, a filled oxygen store prevents the occurrence of HC and CO breakthroughs when the exhaust gas briefly passes into the rich range, since under rich exhaust-gas conditions, the stored oxygen firstly reacts with the excess HC and CO before a breakthrough occurs. In this case, the oxygen store serves as a buffer against fluctuations around λ=1. A half-filled oxygen store has the best performance for intercepting brief deviations from λ=1. To detect the filling level of the oxygen store during operation, use is made of lambda sensors (e.g., most systems have two oxygen sensors in the exhaust that report to the ECU as in one in the engine-out position, and another downstream of at least the first CC catalyst (or sometimes behind two CC positioned catalysts)).

Aspects of the present invention include use of TWC materials that comprise platinum group metals, e.g. Pt, Rh and Pd. To incorporate components such as platinum group metals (e.g., palladium, rhodium, platinum, and/or combinations of the same), stabilizers and/or promoters, such components may be incorporated in the slurry as a mixture of water soluble or water-dispersible compounds or complexes. Typically, when PGM components, e.g. Pt, Pd and/or Rh, are included in the washcoat, the component in question is typically utilized in the form of a compound or complex to achieve dispersion of the component on the metal oxide support.

### HC-Trap Material

The present invention features a uf-HCT having storage material for hydrocarbons (HC). Suitable storage materials for hydrocarbons include micro-porous solids, so-called molecular sieves, with zeolitic material representing a suitable micro-porous solid for HC trapping. Storage materials such as zeolitic (or zeotype) materials have a porosity suitable for storing or capturing hydrocarbons at least until a desired desorption temperature is reached. That is, the hydrocarbons are adsorbed while the exhaust gas is cold (for example during a cold start) and are desorbed and converted when a higher exhaust-gas temperature is reached. The conversion of the hydrocarbons takes place mostly at catalytic centers, such as for example PGM. It is therefore preferable in many situations to integrate the hydrocarbon-storing materials into a three-way catalytic converter in order to store the hydrocarbons when the catalytically active centers are not yet active, and to desorb said hydrocarbons when the catalytic centers have reached their light-off temperature. FIG. 3A provides an example of an individual layering technique for providing a TWC and HCT combination. In this case, according to the invention, the hydrocarbon store may be integrated into the downstream uf-monolith (e.g., a honeycomb supporting substrate), together with a catalytic TWC-function.

Zeolytic material is a material based upon the structural formalisms of Zeolites or Zeotypes generally having the following characteristics:

Zeolite: Zeolites are microporous crystalline aluminosilicate materials characterized by well-ordered 3D structures with uniform pore/channel/cage structures of, for example, 3 to 12 A or 3 to 10 A (depending on framework type) and the ability to undergo ion exchange to enable the dispersion of catalytically active cations throughout the structure.

Zeotype: Zeotypes are structural isotypes/isomorphs of Zeolites but instead of a framework structure derived of linked Silica and Alumina tetrahedra they are based upon for example: alumina-phosphate (ALPO), silica-alumina-phosphate (SAPO), metal-alumina-phosphate (Me-ALPO) or metal-silica-alumina-phosphate (MeAPSO).

Some suitable zeolitic materials compose, for example, mordenite (MOR), Y-zeolites (FAU), ZSM-5 (MFI) and β-zeolites (BEA) or mixtures thereof. These are preferably used in H-form or NH₄-form being exchanged with transition metals.

As already stated the HC-trap of the present invention preferably comprises a catalyst having, for example, TWC-functionality or optionally OC functionality. Reference is made to above mentioned explanation concerning the TWC washcoat. Preferably metals are applied, such as Pt, Pd, Rh and mixtures thereof in association with materials like mordenite (MOR), Y-zeolites (FAU), ZSM-5 (MFI) and β-zeolites (BEA).

Hence, the catalyzed HC-trap preferably includes an adsorber material containing zeolitic material together with preferably a three-way catalyst layer having PGM, like Pt, Pd and Rh. The present invention, with the below described additional features as in controlled supplement oxygen supply means and an HC-trap, functions well at low PGM levels, preferably well below those mentioned above for normal TWCs. Optionally the HC-trap can be utilized with an OC catalyst in place of a TWC, but to facilitate satisfying the more difficult emission level standards as in LEV III or SULEV30, particularly the NOx out levels, the addition of a downstream TWC or SCR or LNT may be helpful in view of the typical poor NOx removal performance in OCs used alone (although, as noted above, NOx levels are not as pronounced as other prior art systems due to the ability to more easily run at stoichiometric or rich).

Thus, under embodiments of the present invention, the HCT itself can be provided with material in addition to the trapping material (e.g., trapping zeolites), as in the HCT containing a PGM material, such as Pd, so as to provide an HC-trap with enhanced trapping and conversion of NOx and HCs characteristics. For example, under an aspect of the present invention, there is provided Pd as the only PGM material in the HCT on the basis that such a combination is considered to enhance alkene (ethene/ethylene) and propene adsorption as well as aromatics. For example, an aspect of the present invention is considered to provide an efficient usage of PGMs by having 13 g/cu.ft. and 100 g/cu.ft. of PGM such as Pd alone in the HCT layer (e.g., together with the zeolite material). Embodiments also feature one or more transition metals in the HCT either (with or without the noted PGM) such as Fe, Co, Ni, Cu, Ag and mixtures thereof, with Fe being well-suited for the purposes of the invention (e.g., cold start trapping and later lean environment during the desorption period). When such transition metals are utilized, a loading of 0.5 to 15 wt % is preferred, with 1.0-6.0 wt % being more preferred for many embodiments.

Also, as described above, if there is utilized a TWC layer over the HCT material, it is preferable if the TWC, when present in the uf-HCT, have a PGM as in Rh, as Rh is considered to be the most resistant PGM for negative interactions relative to HCT poisoning material (such as silica (when present)) in the HCT layer for TWC activity. When the PGM is Rh, the TWC PGM loading is preferably 1.0 to 75 g/ft³, with 5-25 g/ft³ being well suited for many embodiments. When the PGM is Pd, a preferred loading is of 5 to 300 g/ft³, with 10-100 g/ft³ being more preferred under many embodiments. Optionally, Pt can also be added to the TWC layer in loadings of 1.0 to 50 g/ft³.

### Catalyzed HC-Trap Material and Washcoat Application Example

In an example of preparation of a suitable catalyzed HCT (hereafter CAT-HCT) for use under an embodiment of the present invention, an HCT layer is first supplied as a washcoat layer to a support substrate. Accordingly, the CAT-HCT preparation includes the formation of a HC-trap layer that is formed by first preparing a slurry beginning with the addition of an alumina stabilized Silica sol from Evonik Industries AG called AEROPERL 3375/20 to water and mixing. This material represents 4.5 wt % of the final calcined washcoat “WC” loading. This step was followed by the addition of a boehmite, SASOL SCF-55 and Fe nitrate at contents of 1.0 and 4.5 wt % respectively of the final calcined washcoat. Finally the beta zeolite in the ammonium form and having a SAR value of 25 was added and the slurry aged for two days. This example of having a SAR value of 25 is illustrative of a suitable SAR under the present invention, as it falls within a preferred SAR range of 5 to 500, as well as the preferred sub-range of 15 to 100 for many configurations of the present invention. This slurry was then coated onto a ceramic substrate have 400 cpsi/6.5 mill cell structure and 4″ round by 6″ long giving a total volume of 1.2 Liters and a WC load of 4.0 g/in³ or 258 grams/Liter.

The CAT-HCT includes a TWC overcoat as to render the HCT a catalyzed HCT. The TWC overcoat was provided by a washcoat process as well. That is, after application of the HC-trap layer, the TWC layer was prepared and applied to the HC-trap layer and included alumina stabilized with 4% by weight of lanthanum oxide, barium sulfate and a mixed oxide oxygen storage material with a composition of 68.5% ZrO₂+HfO2, 24% CeO2, 4% Y₂O₃ and 3.5% La₂O₃.

A slurry was prepared by first adding alumina to demineralized water and milling (using a Sweco type mill) such that the d50 was 5.5-6.5 microns and the d90 was 12-20 microns. BaSO4 was then added while stirring followed by La(CH₃CO₂)₃ (lanthanum acetate) and the oxygen storage (OS) material. Nitric acid was co-added so as to maintain a pH of 5.0-7.5 during the OS material addition. This slurry was stirred for 20 minutes and then milled a second time such that the d50 was 4.1-4.9 microns and the d90 was 10.5-18.5 microns. The slurry was then weighed and the LOI (loss on ignition) measured at 540° C. to determine the total calcined solids content. Based on this value the respective weight of Pd and Rh solution needed was calculated. Rh nitrate solution was then added to the slurry dropwise while stirring. After one hour the Pd solution was subsequently added dropwise while stirring. During the Pd solution addition, TEAOH (Tetra-ethyl-ammonium Hydroxide 35% solution) was co-added to prevent the slurry pH from going below 3.0-3.5. After all the Pd was added the pH was adjusted to a final value 5.2-5.5.

After slurry preparation, the TWC WC had a specific gravity or density of 1.20-1.40. This WC was then applied to the honeycomb ceramic monolith that contained the HCT layer using a mechanical piston coater. The slurry completely filled the ceramic channels for a brief period and then evacuated first by the piston retraction and then using a vacuum (75-250 millibar) to clear and remove any excess material so as to obtain the desired targeted loading. Washcoat loading was controlled by varying specific gravity, and other coating parameters such as vacuum time. After applying the washcoat, the parts were calcined at 540° C. for 2 hours. After calcination the composition of the TWC catalytic layer was as follows:

40.7 g/l Lanthanum-stabilized alumina;

40.7 g/l oxygen storage material;

9.8 g/l Barium sulfate;

0.352-2.65 g/l Rhodium; and

0.2-7.5 g/l Palladium.

### Control System

The control system of the present invention can comprise an individualized control unit CU for the purpose of CTA functioning or, more preferably a control unit that is integrated with (a sub-unit thereof) a vehicle control system such as a standard engine control unit 44. The control unit CU embodiment example of the present invention thus features a supplemental engine control unit that is integrated with a standard ECU to take advantage of pre-existing various sensed parameters associated with CTA performance, and those parameters are utilized to fashion the appropriate oxygen (e.g., air) injection timing. This includes, for example, sensing the temperature of the ambient air being fed within the system (e.g., at an engine's air intake box), the engine heat level (which can be correlated with the engine exhaust), and/or the exhaust temperature as in one or more of the various thermocouple locations as in the one featured in FIG. 4, the engine rpm level, the chemical attributes as in current composition of levels of various substances or other “state-of-being” or “modality” information relative to the passing exhaust gas at one or more of the exhaust passageway locations, such as locations M1 to M3 shown in FIG. 4 (e.g., the control unit can utilize the lambda sensors alone as in one or more of the UEGO and HEGO sensors, preferably in conjunction with some temperature feedback as in at the downstream end of the HCT).

In an embodiment of the present invention, the sensed information is used to come to a determination as to supplemental oxygen supply characteristics as in an oxygen (or air) injection triggering point and duration timing such that there is provided a sufficient excess oxygen supply as to meet a suitable (e.g., pre-determined) mass flow (or k) level and duration relative to the maximum amount of desorbed HC being experienced within a timeframe (predetermined or sensed desorption timeframe). For instance, an embodiment of the invention features a control unit CU that is configured to receive an oxygen level input such as an input generated by an oxygen sensor (at a location between the cc-TWC and uf-HCT as in just upstream of location P2) which is stored in the control unit as an engine out oxygen level “X”, and a determination is made (e.g., a value based on current engine parameters and/or exhaust gas composition measurement at the uf-HCT) as to the preferred oxygen level PO to remove the current level of desorbed HC's of the uf-HCT, with the supplemental oxygen supply means being instructed by the control unit CU as to the amount of make-up oxygen “Y” required to reach PO (i.e., X+Y=PO). This control function of control unit CU can be carried out on a continuous basis as in millisecond cycling.

In other words, the sensed information is considered by the control means of the present invention (e.g., the supplemental enhanced electronic control unit CU as a sub-unit of ECU 44) to come to a determination as to what amount of oxygen supply is best suited for avoiding undesirable pollutant levels being exited from the overall exhaust emission system. Once this determination is made, the controller of the present invention triggers/controls operation of supplemental oxygen supply means 64 (e.g., see FIG. 3 supplemental ambient air injection means). This supplemental oxygen supply is particularly useful during light-off HC desorption from an uf-HCT following a cold start HC adsorption phase at the uf-HCT. The algorithm used to operate the pump includes logic that utilizes, for example, one or more of engine run time, coolant and/or ambient air temperature conditions, battery source power levels, etc. as enabling criteria.

As shown in FIG. 2, the supplemented ECU with control unit CU, operates, under an embodiment of the present invention, not only on engine E operation, but also CTA operation (as described in more detail above and below). As seen in the FIG. 2 embodiment, the CTA communicates with ECU 44 (and also with CU relative to certain sensed data) to facilitate coordinating supplemental oxygen supply with respect to a desorbing uf-HCT.

The arrangement of the present invention with supplemental oxygen supply as at the illustrated FIG. 3 P2 injection reference point also provides for enhanced temperature manipulation and thus a temperature based uf-HCT control, which facilitates coordination of the HC desorption rate relative to a given flow rate temperature environment, and pollution levels in need of removal. In other words, the control unit CU can set an ambient air (cooler than the exhaust temperature at the point of introduction) flow rate that can retain, for example, a temperature that is within a predetermined range relative to the light-off temperature. Also, a temperature cap of, for example, 400° C. can be set as to avoid initiation or continuation of lean running on the basis that the temperature has reached a level indicative of completion of desorption and the inability to adsorb Also, the controller is preferably set to disable the system when the ambient air is too cool (e.g., less than 45° F. (or less than 48° F.) as to avoid pump operation where temperatures may fall below freezing).

An additional aspect of the present invention features the control CU operation for supplemental air supply as being based on modeled HCT temperature alone without sensor input or with, for example, exhaust temperature sensing (e.g., a thermocouple such as Ts1) in the exhaust to directly measure the temperature to confirm the modeling is within pre-prescribed ranges.

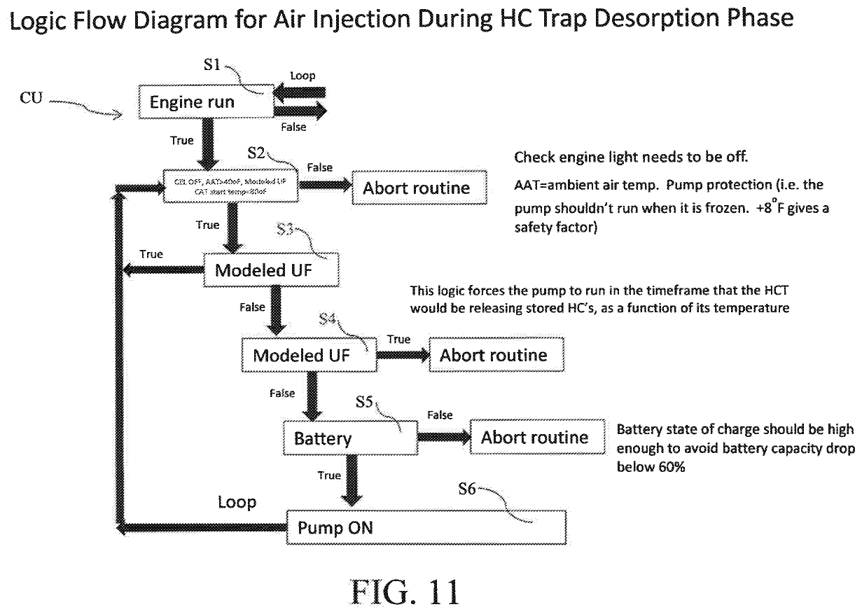

FIG. 11 shows a Logic Flow Diagram for Air Injection During HC Trap Desorption Phase under an embodiment of the present invention. As seen therein, there is a loop approach in the logic flow sequence starting with the control unit carrying out Step S1 wherein there is determined if the engine run time has surpassed 5 seconds (confirmed run mode). If false, the loop return is implemented, if true, the control unit CU carries out Step S2 wherein each of the following “system ok” checks are made which include:
(i) a check as to whether a check engine light is on or off;
(ii) a check as to whether or not the ambient air is greater than a predetermined temperature, with 40° F. shown as an example as it provides a +8° F. factor of safety relative to freezing temperature of 32° F.; and
(iii) whether the CU stored modeling temperature for the uf-HCT is less than a predetermined temperature, with a temperature of 80° F. shown as an example of a modeled too low base temperature.

If the CU determines, relative to each of the checked parameters (i), (ii) and (iii), respectively, that the check light is on; the ambient air is not greater than the set predetermined temperature (e.g., 40° F.), or the base temperature of the uf-HCT has not reached the set predetermined temperature (e.g., 80° F.), the program is aborted for this engine run cycle or trip.

If, on the other hand, each of (i) to (iii) is deemed satisfied, control unit CU moves to Step S3, wherein a determination is made relative to a predetermined modeled temperature for the engine system operating as to whether or not the uf-HCT is considered to still be under a second predetermined set uf-HCT lower operation threshold temperature, with 120° C. shown as an example. If the modeled uf-HCT temperature is deemed to be below the modeled temperature level for uf-HCT at Step S3, there is carried out a CU return loop back to Step S2 for a review of checks (i) to (iii) described above. Thus, if the determination is true (<120° C.) the system returns to Step S2, if false (at or above 120° C.) control unit CU is configured to move to Step S4 wherein a check is made as to whether an upper threshold temperature for the uf-HCT has been surpassed (e.g., uf-HCT modeled temperature considered to be above 400° C.). If true (e.g., the modeled uf-HCT temperature is deemed to be above 400° C.), there is aborted the routine for the trip as there is deemed to be a situation wherein there would not be a state of HC desorption (or adsorption in view of the modeled high uf-HCT temperature). If a false determination is made at Step S4 (e.g., modeled uf-HCT temperature deemed not above 400° C.), control unit CU is configured to proceed to Step S5 wherein a power source check (e.g., a battery storage level check as in a vehicle's main “start battery” storage level) for the power source used to run the supplemental oxygen (e.g., air) supply means (e.g., pump) is made. For example, in FIG. 11 at Step S5 if the power source battery state of charge (“SoC”) is deemed not greater than a predetermined level (e.g., the 60% illustrated) there is aborted the routine for trip.

As further shown in FIG. 11, if there is deemed to be a suitable power source status (e.g., battery charge status sufficient), control unit proceeds to trigger activation of that power source to initiate the supplemental oxygen supply (e.g., activating and running an air pump such as pump 76 which is activated by controller 84 until triggered to deactivate as based on modeled parameters and/or real time sensed parameters).

Thus in FIG. 11 there is shown Step S6 as activation and running of the supplemental air supply source with a CU return loop back to Step S2 for a review of checks (i) to (iii) described above.

### Federal Testing Protocol (FTP) And DFCO Operation

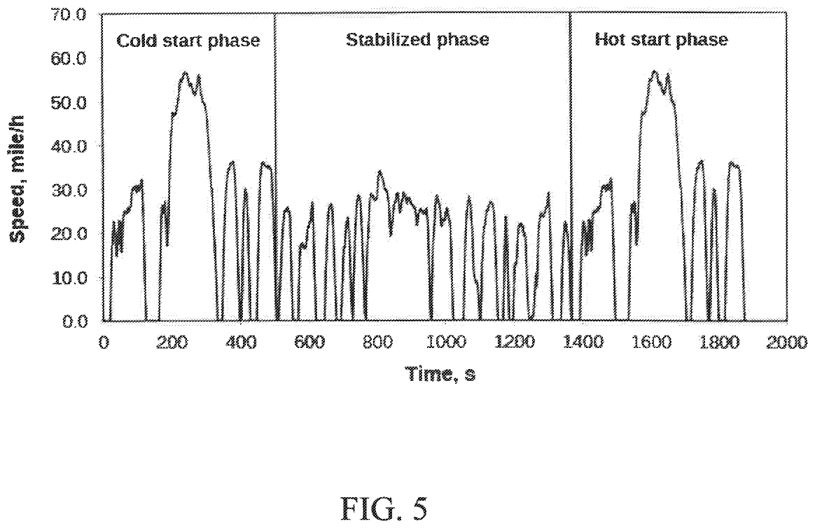

FIG. 5 shows the speed, time and various phases associated with a FTP cycle testing for regulation conformance. As seen from FIG. 5, under the FTP there is a “cold start” phase for the first 505 seconds of speed (mph) cycling of an engine. Each phase is shown as having multiple varying cycles as represented by the peak ranges between zero mph and states of different heights and durations, as to simulate various engine conditions experienced on the road.

As noted above, for those systems operating with a “deceleration fuel cutoff” or “DFCO” the control system associated with those systems provides an oxygen enhanced environment during a DFCO cycle. In other words, “DFCO” operates to shut off of fuel supply when deceleration is sensed as to provide extra oxygen to the uf-HCT downstream via an engine-out oxygen increase, but for many engine systems that extra oxygen is not timed properly and thus is not well suited as to avoid the noted higher pollutant ranges, as in values that do not satisfy LEVIII during certain phases of engine system operation (e.g., can fail the FTP cycle testing under some situations). For example, many gasoline engines do not go into DFCO mode during the desorption phase on an uf-HCT or fail to start DFCO sufficiently early enough relative to the desorption stage, and thus are unable to properly handle the high HC and low oxygen supply situation that occurs during at least a portion of desorption at light-off temperature conditions. The speed trace during the FTP drive cycle dictates this to a large extent also—the relative portion of decelerations during the time domain where release occurs is small. Even if an engine system were to provide a degree of DFCO operation during the desorption phase, there would remain issues with proper treatment of HC flow downstream during the desorption phase, and difficulty in satisfying the rather stringent LEVIII (and other regulatory) requirements, such as with respect to the summed NMHC (or NMOG) plus NOx amount requirements associated with those stringent regulations.

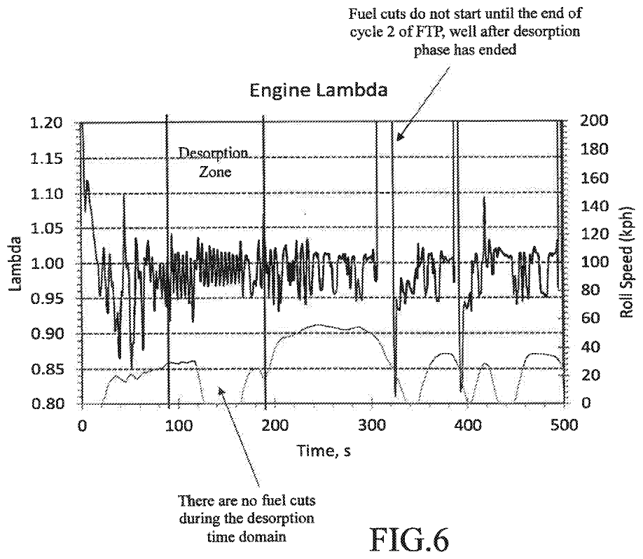

FIG. 6 shows the FTP roll speed (on a different scale than shown in FIG. 5 and thus is shown as more compressed in height) as well as the engine lambda value over a period of 500 seconds on a typical engine system operating under a FTP protocol.

As seen in FIG. 6, at the initiation of the cold start cycle the lambda values drops from a lean start state and into a generally heavier rich state period. This cold start period wherein HCs are trapped by the uf-HCT since the cc-TWC has yet to reach light-off temperature, is followed by a desorption zone (after sufficient heat up to lead to the release of HC in the catalyzed uf-HCT). This desorption zone is shown in FIG. 6 extending from about 65 seconds to 210 seconds (i.e., a desorption state range from above 65 seconds to 210 seconds). A typical DFCO used in a variety of engine systems, however, does not start until the later part of cycle 2 (e.g., about the 300 second mark) wherein the desorption stage has well earlier been completed (e.g., at the 210 second mark). This thus shows that for many engine systems featuring DFCO operation, the extra lean state associated with the shut off of fuel supply in a DFCO cycle occurs well after the desorption phase has ended. Therefore, the DFCO is not available in these systems to remedy the lack of oxygen at the catalyzed uf-HCT to satisfy some of the more stringent requirements such as those associated with LEVIII.

The arrangement of the present invention is designed to provide a more universal approach that doesn't rely on DFCO availability (either from an overall presence standpoint or a lack of appropriate timing when present) or suitability (e.g., lack of satisfaction of stringent regulations even when DFCO supplies engine sourced oxygen to the system). Thus, embodiments of the invention work well in gasoline engine applications with or without deceleration fuel cutoffs being utilized. Accordingly, an embodiment of the invention is one that works together with DFCO, as it is able to still supplement the O₂ introduction by DFCO's, since DFCO is often limited in terms of operating region.

### Illustrative Exhaust Emission System With Oxygen Supplementation System

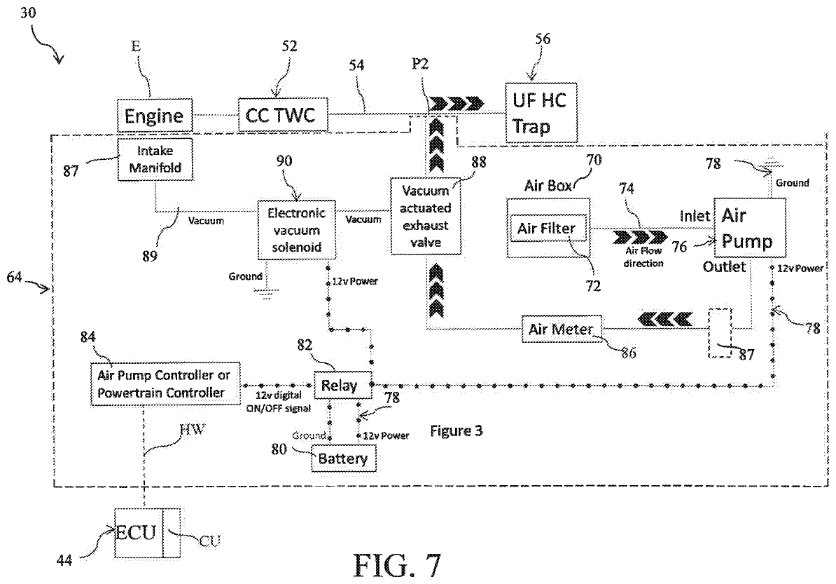

FIG. 7 illustrates an embodiment of an exhaust emission catalyst treatment apparatus CTA of the present invention. As seen from FIG. 7, under the present invention the CTA includes oxygen supplementation means 64 which, under aspects of the invention, features a non-engine-out sourced supplemental oxygen supply provided at a location preferably downstream of the cc-catalyst such as the cc-TWC system 52. A preferred embodiment features taking advantage of air as the source of oxygen (e.g., about 79% N2/21% O₂/etc.), and preferably ambient air. In other words, while a compressed oxygen or air source container system is envisioned as a possible oxygen supplementation means, a more preferred oxygen supplementation means for many embodiments of the invention is one that draws in ambient air and controls the supply. From an electronic control aspect of air injection control there is featured the above noted control unit CU either in communication with a standard ECU, or control unit CU can act in standalone fashion. From an oxygen gas flow control standpoint, there is featured the appropriate supply means such as a pump with clean ambient air intake and an air flow controlled (mass flow and on/off timing) mechanical supply system.

FIG. 7 shows an example of a suitable oxygen supplementation means 64 that feature an air injection system as the means for providing oxygen supplementation. The oxygen supply supplementation means 64 shown in FIG. 7 represents an embodiment of the invention that takes advantage of existing equipment often found in vehicle systems, but provides modification directed at the purposes of the present invention of strategically providing supplemental oxygen to offset the loss of oxygen across the upstream catalyst (e.g., an cc-TWC system (or the like)), and to provide sufficient oxygen at the appropriate time relative to light-off and desorption of HC's at the downstream uf-HCT 56, which is preferably a catalyzed uf-HCT such as a TWC catalyzed uf-HCT

That is, an aspect of the invention features an uf-HCT having an integrated catalyst, as in a TWC. The integration of hydrocarbon trap material and catalyst (e.g., TWC or OC) can be, for example, based upon a common support substrate support such as a coating of a common support substrate as shown in FIG. 3A. This can be for some aspects of the invention a full TWC (or OC) layer overcoat. In other embodiments, there can be featured a common supporting substrate with HCT material and catalyst (“CAT”) zoning of different characteristics [HCT-CAT] zoning on a common substrate. Alternate embodiments of the invention feature sequenced, individual HCT and TWC (and/or OC) functioning catalysts as in a common canister dual substrate support arrangement (HCT/CAT) combo or separate canister in flow passage sequence (HCT-CAT). Also, if OC is opted for as the CAT, additional downstream components such as an SCR and/or NSC is/are added under different aspects of the invention to compensate for the lack of the TWC NOx removal prong of the oxidation catalyst (OC). Selective Catalytic Reduction (SCR) technology is designed to permit nitrogen oxide (NOx) reduction reactions to take place in an oxidizing atmosphere. It is called “selective” because it reduces levels of NOx using a supplied or internally sourced reductant within the catalyst system.

As an example of an HCT/SCR combination reference is made to US Pat. Pub. 2016/0245207 to the common present assignee and listing inventors: Ball, Douglas; Moser, David; and Nunan, John. This US publication is incorporated herein by reference.

An NOx adsorber-catalyst system or nitrogen storage catalyst (NSC) is designed to control NOx emissions. The NSC adsorbers, which are typically incorporated into the catalyst washcoat, chemically bind nitrogen oxides during leaner engine operation. After the adsorber capacity is saturated, the system is regenerated during a period of richer engine operation (e.g., a temporary ECU generated added fuel supply), and released NOx is catalytically reduced to nitrogen. Any standard NOx-trap can be utilized with the above incorporated by reference application entitled “EXHAUST EMISSION REDUCTION SYSTEM HAVING AN HC TRAP AND NOX TRAP COMBINATION DESIGNED FOR OPERATING UNDER STRATEGIC LEAN CONDITIONS” providing additional and enhanced examples and configurations relative to HCT/NOx-trap combinations well suited for use in embodiments of the present invention featuring a HCT/NOx trap combination.

FIG. 7 also illustrates an exhaust emission system 30 that includes engine E and catalytic treatment apparatus CTA (comprising, in the embodiment illustrated, cc-TWC system 52, exhaust line 54, catalyzed uf-HCT 56 and the above and below described supplemental oxygen supply means 64 in the form of an ambient air injection system) as well as means of communication HW between CU and the ambient air injection system (e.g., hard wiring is preferred in light of the intended environment). The FIG. 7 illustrated air injection apparatus 64 comprises an air box 70 into which flows air, as in a direct ambient air (environmental air) flow intake. Air box 70 can be a standalone air box with associated filter 72 (e.g., one dedicated to the supplemental oxygen supply means or air injection apparatus 64 alone), but more preferably takes advantage of a vehicle's current equipment by use of a vehicle's standard air intake box such as that feeding filtered air to the engine. Under either scenario, there is provided a flow line segment 74 extending between the outlet of the air filter (e.g., a “PCV” style air filter) 72 and an inlet of air pump 76 to filter out undesirable particulates from reaching the air inlet of the air pump 76.

Air pump 76 is either a preexisting air pump of the vehicle (with suitable bypass valving in the event the air pump is needed for other vehicle requirements when system 64 is non-operational) or can be a standalone (i.e., a pump dedicated only to the supplemental oxygen supply system 64) air pump. Air pump 76 is suitably mounted relative to the vehicle, as, for example, by an engine mount bracket. As shown, pump 76 is also preferably grounded (as a feature of the overall electronic circuitry 78 also illustrated in FIG. 7 by dotted lining as one example of a suitable manner for powering the air injection apparatus 64). FIG. 7 presents enlarged air flow direction arrows to help explain the relative air flow through the air injector apparatus 64 air processing components.

The electronic circuitry 78, as shown in FIG. 7 is, one that preferably makes use of existing vehicle electronics as in the illustrated 12V electronic circuitry that is sourced from a standard vehicle battery (although alternate power source means are contemplated including standalone power sources such as a standalone battery independent from the standard “start” battery of a vehicle). As also shown in FIG. 7, appropriate grounding and circuit lines are provided between the noted electronic components of the supplemental oxygen supply means or air injector apparatus 64 shown, as well as an integrated vehicle's electronic fuse box to compensate for shorts and the like (not shown).

A preferred pump 76 is one that can supply on demand air at a fast rate (at or less than 3 (or less than 2) seconds) suitable to satisfy the oxygen supply needs feeding to the (preferably catalyzed) uf-HCT 56, which is a single or multiple (catalyzed and/or non-catalyzed) HCT system. A suitable pump is a vacuum actuated air pump (e.g., a Siemens A.G., vacuum actuated air valve and pump combination). This pump is well suited for avoiding time delays from the time the control means (e.g., CU of ECU 44) triggers a request for supplemental oxygen as to provide for enhanced coordination of oxygen supply at a time of HC desorption at the HCT. In other words, embodiments of the invention make use of a pump system that is on demand and rapidly outputs the needed supplemental air.

Air pump 76 is shown connected to the power source 80 (standard vehicle battery, for example) via electronic relay 82 that is also shown in communication with pump controller 84. Pump controller 84 provides pump control output to the supplemental oxygen supply means or air injector apparatus 64. Also, as featured in FIG. 7, pump controller 84 can be an air pump controller or a powertrain controller (for supplemental powering of a pump rotor, for example), and can either be an independent control unit (a CPU, a ROM, a RAM, and a backup RAM etc.) or can be a sub-component of a more generic control unit as in the above described CU and/or Engine Control Unit 44 (with the dash-line linkage HW featured in FIG. 7 symbolizing either: i) a standalone pump controller 84 in communication with CU and/or ECU 44 as in being physically separated therefrom as a component of the pump assembly itself (and thus appropriate sensed signals fed to the ECU and/or CU can be relayed and utilized by controller 84 for air pump operation), ii) an actual subcomponent of CU and/or ECU (having a common bus communication for sensed information receipt by subcomponent 84) and a communication link directly to the pump for activation and shut-down.

Air injection apparatus 64 is further shown as having an air flow meter 86 (e.g., a flow regulator set to a predetermined or currently set flow rate) that receives air from the pump output and meters the air flow that flows to the vacuum actuated exhaust valve 88, which can be set to allow air to flow to exhaust line 54 (FIG. 3), as at point P2, once opened. In this embodiment, point P2 is set at a location before or upstream of uf-HCT 56 as to provide it with supplemental oxygen at a strategic time relative to desorption of hydrocarbons previously bound by the uf-HCT, as in an earlier adsorption during a cold start phase. In this regard, reference is again made to the adjustments in airflow (e.g., via fine pump control to accommodate a period of initial desorption where some HC's are re-adsorbing on the cooler downstream end of the HCT).

The communication between the controller 84 and air meter and/or air pump also provides a means for temperature regulation of exhaust gas reaching uf-HCT. For example, there can be coordinated both the need for supplemental oxygen for a uf-HCT operating at a predetermined capacity and the temperature at the reaction location of the uf-HCT (e.g., a greater flow rate of ambient air can supply a desired supplemental oxygen and lessen the temperature at the uf-HCT, for example, if it is desired to delay initiation of the light-off temperature until a desired oxygen supply is in place).

In an alternative embodiment, to further fine tune the providing of the desired temperature at the uf-HCT when factoring in ambient air temperature air, (which in colder climates can be far below the UF exhaust temperature), a heater 87 can also be controlled via controller 84 to lessen the differential between ambient air and UF exhaust temperature such that there may still be provided an overall cooling effect, but with less of a temperature differential (and with a temperature and air flow rate well suited for efficient desorbed HC removal generated by the uf-HCT). In addition, the heater can be utilized to speed up the time to reach light off temperature and then shut off at the desired time relative to supplemental air injection. Heater 87 can be a dedicated heater as in a resistant heater or one that utilizes heat exchange and bypass valve based warming with other heated regions of the vehicle.

In the system shown in FIG. 7, use is made of the auxiliary power provided by the vacuum generated during engine operation. That is, since manifold vacuum is present as a natural byproduct in internal combustion engines that use the Otto cycle (i.e., gasoline engines used in passenger cars, trucks, etc.), the manifold vacuum can be harnessed as an auxiliary power source. In this case, vacuum line 89 is in communication with intake manifold 87 at one end and with electronic vacuum solenoid 90 at its opposite end. Thus, when the controller CU determines that air flow to the exhaust line 54 is desirable, the relay 82 is triggered by a control signal from pump controller 84 such that the electronic vacuum solenoid 90 receives electrical power along circuitry 78 and is released to allow for the vacuum state to exist in vacuum line 92 (which extends from the vacuum solenoid 90 to vacuum actuated exhaust valve 88). Accordingly, after such a triggering of events, supplemental oxygen (sourced from ambient air box 70 in this embodiment) and pressurized and metered to a desired flow rate is injected into exhaust line 54 rapidly at a point P2 which, in this instance, is positioned just upstream (e.g., within 10 cm as within 6 cms—inclusive of 0 cms, as in canister injection).

The system shown is beneficial in that it makes use of the natural auxiliary vacuum source power and thus provides a low energy drain relative to the electronic circuitry with battery power source and avoids survivability issues relative to, for example, an electronic valve mounted close to the exhaust (although alternate embodiments include such a possibility with suitable environmental protection or positioning). That is, with the benefit of the understanding provided by the present invention discussion, one of ordinary skill in the art would also appreciate that other actuation means, other than the described electronic vacuum solenoid and vacuum actuated exhaust valve, for supplying supplemental oxygen can be implemented (e.g., a system which relies on an electronic only solenoid that utilizes battery sourced or other means of providing power that is associated with a vehicle or a standalone source not commonly provided with a vehicle).

Although shown schematically in FIG. 7, the pump and associated hardware can be mounted according to various configurations in the engine bay and/or underside of the vehicle. The other shared vehicle components as in, the noted filtered air intake (70, 72), the intake manifold 87, battery 80, control unit CU (when part of an ECU used for engine control in general) are positioned in their normal vehicle operational position

### Method of Operation Example

One mode of operation under the present invention, includes passing exhaust gas exiting from a vehicle engine, as in a gasoline fueled vehicle engine (such as one of the above described engines inclusive of GDI, PFI, SEC, GDCI gasoline based vehicle engines) past an upstream cc-catalyst system, as in the illustrated cc-TWC system 52 (which can be one with a single cc-TWC or multiple cc-TWC's). The operation of cc-TWC 52 is carried out, for example, at stoichiometric or light lean conditions (e.g., GDI leaner operation) wherein there is sufficient engine-out oxygen to enable the two oxidation prongs of the TWC (CO and HC to CO₂ and H₂O) without too much deterioration of the third reduction prong involving the reduction of NOx to N₂. However, as described above it has been determined that some standard cc-TWC compositions lead to an inadequate oxygen level downstream thereof, where it is needed to handle the increase in HC into the exhaust flow brought about by a desorption of HC at light-off relative to the uf-HCT. Also, the arrangement of the present invention also provides for more easily enabling the normal engine calibration operation during the time of desorption (and hence lowered NOx generation) as in the engine running predominately stochiometric with the potential for rich running (such as during a TWC AFR toggling operation by the ECU in the gasoline engine).

Under an aspect of the present invention, a CU controlled and well-timed feeding of supplemental oxygen, as by way of ambient air injection system 64 and controller 84 (e.g., a component of control unit CU), is carried out to offset the lacking oxygen level upstream of a reaction area for a downstream uf-HCT (preferably catalyzed with TWC material). This, in turn, leads to an improvement in overall exhaust emission clean-up and the ability to facilitate efforts to satisfy all aspects of the more stringent emission control requirements, such as those set forth in LEVIII inclusive of the above described NMOG+NOx summation category found to be one of the more difficult to satisfy, particularly when an uf-HCT is involved (in other words—the benefits of a uf-HCT, insofar as helping avoid HC escape during the cold start phase, newly introduces added complexity relative to pollutant removal at the time of light-off and release of previously trapped HC's at the uf-HCT).

### Manufacture of the Exhaust Emissions System

The manufacturing method of the present invention is inclusive of the assembly of all components associated with, for example, system 30 shown in FIG. 7, at a time of initial assembly of all components. An alternative embodiment, particularly since many components of CTA and/or oxygen supplemental means 64 share vehicle preexisting or already utilized components for general vehicle operation, features a supplementation of a preexisting vehicle assembly as in retrofitting or modifying an already assembled (e.g., inclusive of an already used) vehicle. Additionally, the upstream cc catalyst and/or downstream uf-HTC (catalyzed or non-catalyzed) can be specifically adapted for use with the oxygen supplementation means or a preexisting catalyst set up can be utilized with the supplemental oxygen supply means of the present invention.

For example, in manufacturing exhaust emission system 30 under a retrofit approach there is added in air injection system or oxygen supplementation means 64 to a preexisting catalyst system having upstream catalyst (e.g., cc-TWC) and a downstream uf-HCT, inclusive of a catalyzed uf-HCT, if present, as in one with a TWC overcoat of a zeolitic material uf-HCT. However, embodiments of the invention are inclusive of coordinating the oxygen supplementation means with the CTA make up as to make both work together in a goal to facilitating meeting the more stringent emission requirements as in LEVIII).

In an aspect of the present invention, the supplemental oxygen introduction (as by ambient air injection system 64) is achieved by way of pumping ambient air to the noted oxygen supplementation location relative to the uf-HCT, with operation of the pump being controlled by a controller for providing pertinent timing and duration of oxygen supplementation during the above noted time frame when HC desorption can generate an undesirable level of pollutants in the absence of the controlled oxygen supplementation. The air injection apparatus, such as air injection apparatus 64, features, under one embodiment of the present invention, the use of an engine intake manifold vacuum source to provide power for adjustment in solenoid or the like to trigger a flow valve that when opens provides for the supplementation of ambient air (oxygen) at a desired pre-pressurized and flow controlled state to the pertinent location wherein there is a light-off temperature or higher and an ongoing release of HC previously stored by an uf-HCT.

### Method of Manufacturing

A method of manufacturing a catalytic system or catalytic treatment apparatus (CTA) is featured under the present invention as well. An example of such a method includes assembling together, in line, along a vehicle exhaust gas conduit, as in vehicle exhaust gas conduit 54 (e.g., a gasoline source combustion engine exhaust line) an upstream (e.g., cc catalyst) such as cc-TWC 52 and a hydrocarbon adsorber or trap, such as uf-HCT 56, as a downstream component on that exhaust gas line which, as explained above, is preferably a catalyzed uf-HCT, as in one with TWC material (such as the layered approach shown in FIG. 3A).

The method of manufacturing of the CTA further includes providing a supplemental oxygen supply means with associated control component (as either a component of the CTA itself or one that interfaces with the CTA, with the CTA being adapted (set up) to receive control unit CU directions) configured to ensure sufficient supplemental oxygen is supplied to the uf-HCT at the time of HC desorption such that there is avoided the problem of deficient oxygen supply at the uf-HCT due to, for example, the cc-TWC operating to remove too much of the oxygen supplied in the engine-out exhaust.

An example of the assembly steps for assembling a supplemental oxygen supply means 64 within a CTA system includes providing an air injection system 64 (FIG. 7) that features the components described above for FIG. 7 (adding and assembling those that are not already present on the vehicle; which, if already present on the vehicle is/are modified to the extent necessary to coordinate with the other components described above that are not already part of the vehicle system). Thus, under this example, there is assembled as a sub-assembly for combination with the above described exhaust line 54, cc-TWC 52, and catalyzed uf-HCT 56, the following components: circuitry 78, piping to provide for the above described ambient air circulation and vacuum actuation line system (featured as a preferred air supply/air cut-off actuation means) that is associated with vacuum solenoid 90 and vacuum actuated exhaust valve 88. Furthermore, and again if not already representing a component of the vehicle that can be adapted for use under the air injection apparatus 64, there is further assembled an air box with air filter that feeds to an air pump and an air meter (that is in the air supply piping connected with the outlet of the pump) to control the air flow level that reaches the exhaust line 54 upon the vacuum powered valve 88 opening up to enable metered air flow from the pump and meter combination into line 54 so as to supply the uf-HCT with supplemental oxygen at an appropriate time and rate.

Also, under an example of the invention, a preexisting vehicle relay is modified to have an additional relay feature associated with the triggering of the supplemental oxygen supply as in through use of the vacuum power supply means described above (88 and 90 with communication with a preexisting engine intake manifold via appropriate vacuum piping added).

Also, a preexisting ECU can be supplemented with appropriate sub-control means as in control unit CU and potentially also pump controller 84 in FIG. 7 (e.g., when a separate component from ECU and sub-control unit CU) which is able to determine through appropriate signal input as from modeling and/or usage of preexisting exhaust system sensors (e.g., see FIG. 4) as well as preferably additional standard engine control unit sensing data such as throttle open levels, and air inlet flows, engine rpm levels, etc.). Alternately, the control unit assembled as a part of the present method of manufacturing a CTA for use in an engine emission reduction system, can be a sub-controller (e.g., control unit CU), that is in communication with another of the common vehicle “controllers” (as in the noted ECU 44; and as configured to receive additional signal input associated with the ECU); or can be an independent controller that has its own (sensed and/or modeled) inputs and works independently of other controllers functioning on the vehicle. In one embodiment of the present invention the CU triggers the supplemental oxygen supply means solely based on modeled uf-HCT temperature, although in an alternate embodiment there is used actual temperature sensing to determine the status of the HCT (in which case this temperature can be relied upon alone by the CU (or as a comparison point with a modeled mode).

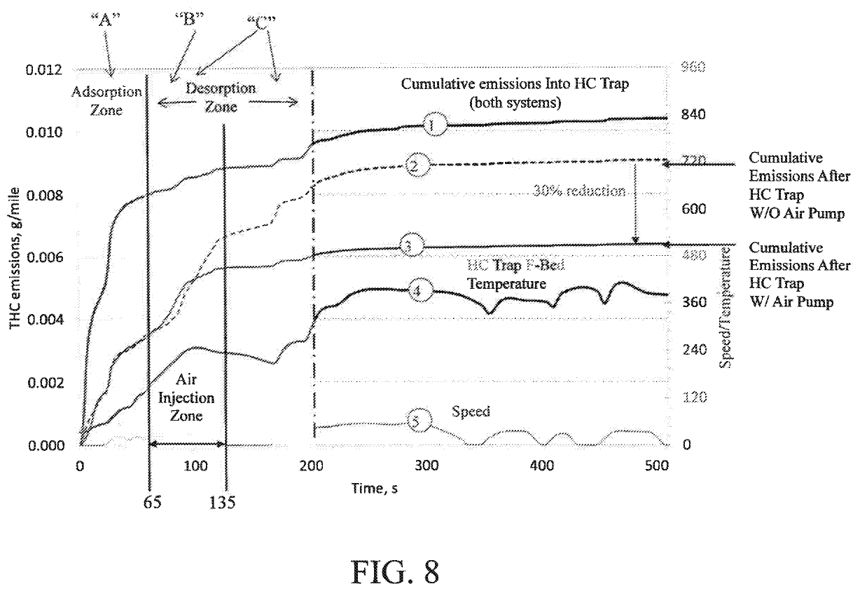

Thus, the manufacturing method of the present invention includes assembling those components of the CTA not already supplied by the vehicle's already present system, such that the assembled components can interface with the vehicle both physically, electrically and relative to data intercommunication for the purpose of emission control. In addition the method of manufacturing the CTA includes an additional embodiment wherein the components not already on the vehicle are interfaced with components on the vehicle such that the CTA is functional on the vehicle such as in the manner presented in FIG. 7. The same is true with respect to assembly of the oxygen supply means 64, if all other CTA features already preexist on a supplied vehicle. In other words, the components not already on the vehicle can include the CTA plus the non-vehicle components as in supplemental oxygen supply means 64 which is assembled on the vehicle. Thus, under a retrofit situation, wherein there is already in existence on a vehicle a cc-TWC and a uf-HCT (or the like), there is supplied to the vehicle (even a previously used vehicle) supplemental oxygen supply means 64 such that it interfaces with the vehicle to supply supplemental oxygen to the uf-HCT at the appropriate time and duration via an added supplemental control unit CU. Embodiments of the invention, however, also include uf-HCT and associated catalyst enhancements as in the layering catalyzed uf-HCT that are designed (physically and chemically) for coordination with the CTA operation under the present invention with controlled enhanced oxygen supply during HC desorption. As also noted above, in view of the period of desorption at the front of the uf-HCT and temporary adsorption at the rear during the initial stages of desorption, the control unit can also adjust accordingly in view of the knowledge that less HC's are being fully released during this initial stage. In this regard, as also seen from FIG. 8 the air injection zone can be terminated prior to the perceived end of desorption, with knowledge of some lag in supply initiation and over the uf-HCT supply, with the below described FIG. 8 showing a termination at about a mid-point plus (e.g., 50 to 80% range of the full desorption period) of the full desorption period.

Thus, relative to the integration of the CTA of the present invention, there is provided for a retrofit of a preexisting exhaust emission system associated with an internal combustion engine E to result in a CTA like that described above and inclusive of a CTA having an air injection apparatus such as air injection apparatus 64 shown in FIG. 7 (with the retrofit including the supply of air injection apparatus not already present and if components are present on the preexisting vehicle appropriate interconnections therewith to complete the assembly of the entire system 30). Further the presence of the present invention in a vehicle is considered to enable a reduction in overall catalyst system PGM usage (e.g., a lower PGM loading in an cc-TWC and/or uf-CAT-HCT) and lower substrate cpsi usage (each presenting a lowering of cost in their respective categories) because the sole reliance on the CC for HC light off is relaxed significantly. Under the present invention it is also considered to be a potential for a reduction in cold start calibration development time required (and thus improved engine performance potential).

### EXAMPLE(S)

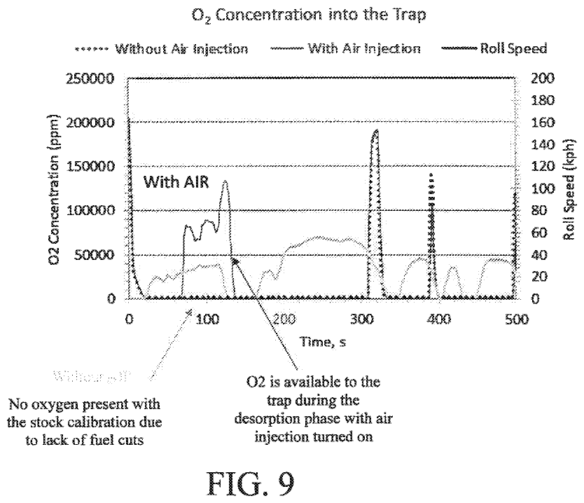

With reference to FIGS. 8 and 9 there can be seen data relative to the operation of an exhaust emission system such as that of the present exhaust emission system 30 invention with oxygen supplementation means 64 supplying oxygen, and one without the controlled supplement oxygen supply means 64. A comparison of the data relative to these two different system states provides an illustration as to how the present invention's exhaust emission system 30 provides for an improved removal of cumulative hydrocarbons (THC's).

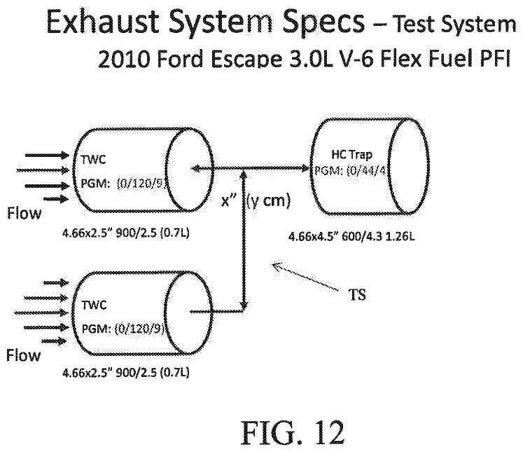

The test set up is schematically shown in FIG. 12 with the FTP test carried out on a 2010 Ford Escape 3.0 L V-6 flex fuel PFI having the following engine specifications and a catalyst arrangement TS as also featured in FIG. 12 (with noted PGM Pt/Pd/Rh loading and relative upstream/downstream schematic depictions for the illustrated EGR (exhaust gas recirculation) system for this established engine) to which the present CU and supplemental oxygen supply means was incorporated for testing purposes.

### Engine Specs

Duratec 3.0 L FFV V-6
240 BHP/223 FT*LBS TQ
18/26 City/Hwy Fuel Economy
6 Speed Auto Trans
EGR, VCT, DFCO
TWC→Three-Way Catalyst
HO2S→Heated Oxygen Sensor
EGR→Exhaust Gas Recirculation
SFI→Sequential Fuel Injection
HAFS→Heated Air Fuel Sensor

From a review of FIG. 8 there can be seen that testing of the noted engine system shown in FIG. 12 is carried out over a period of time (0 to 500 sec) under a standard FTP speed variation (mph) cycling (shown as the bottom most graphing line). The left axis in FIG. 8 shows the total hydrocarbon or THC emission levels (in g/mile) while the right axis shows the temperature level by way of the graphing line positioned immediately above the bottom most FTP speed cycling graphing line. FIG. 8 also shows three zones by way of vertical line demarcations, include the adsorption zone “A” (the time when the uf-HCT is adsorbing HC due to cold start conditions, for example), followed by air injection zone “B” (applicable only to the present invention's system 30 testing as the comparison testing involving only engine-out oxygen levels has no UB oxygen supplementation). FIG. 8 also shows that the desorption zone in this embodiment shares an initial start point with the air-injection zone and then extends past the end of the air injection zone. Alternate embodiments include a start up of air injection just prior to the end of the adsorption zone as well, as just after the start of desorption initiation as in within the first 10 seconds either way. Further, as explained above, the air injection period can stop before the end of the desorption period or can be timed to extend the full length of the desorption period and, less preferably, slightly past the end of the desorption period, as in within 10 seconds of the end of the desorption period. The timing of the air injection relative to the start of the desorption zone “C” is system specific and is designed preferably to continue sufficiently to ensure the removal of the previously adsorbed HC's that are now releasing from the uf-HCT absent an overriding engine control situation, as where the operator needs to accelerate and a return to less than lean operation is favored. For example, in the FIG. 12 test set up plotted in FIG. 8, the desorption phase is shown in a typical completion state at the middle of “hill #2” in the plotting, which is this case is around 225 seconds (where lines 2 and 3 are shown as essentially going to 0 slope).

Accordingly, some timing variations will exist depending upon the type of engine and emission system utilized (e.g., degree of catalytic loading and type of catalysts, the number of catalytic components, etc.).

As further seen from FIG. 8, for an illustrative system embodiment, the starting times (and durations) for the respective zones for the illustrative testing data has the adsorption zone proceeding for about 65 seconds, with an air injection (supplemental oxygen supply) proceeding from about 65 seconds to about 135 seconds, with the desorption zone extending from the end of the adsorption zone and terminating after air injection completion (e.g., 65 seconds to at or greater than 210 seconds as in around the above noted 225 second point).

The invention works well on gasoline applications without deceleration fuel cutoffs (DFCO) capability or with DFCO capability, but with the DFCO timing not being suitably timed as is the case with conventional DFCO timing. The present invention can be used with a DFCO system in place or not. If a DFCO system is in place, the present invention also provides means for supplementation of the O₂ introduced by DFCO's, in view of DFCO limitations in terms of operating region. The supplemental oxygen supply means (e.g., ambient air) injection system 64 works well in many environments such as when a traditional close-coupled TWC is installed upstream of a uf-HCT and the supplemental oxygen (e.g., air injection) point is shown positioned between the cc-TWC and uf-HCT, as the upstream cc-TWC consumes the majority of engine-out oxygen that would otherwise be available to the UB trap. A preferred embodiment avoids having a catalyst component between the injection point of the supplemental oxygen supply means 64 and the uf-HCT. In this way the CU determined timing provides the supplemental oxygen directly after being turned on rather than being damped by an intermediate exhaust line component. Also, embodiments of the present invention can further include the ability to bleed off some supplied air to better fine tune the supplemental oxygen supply to current conditions as well as providing a pump with a variable output as to further fine tune or feather the supplemental oxygen supply to uf-HCT conditions (e.g., see the discussion above relative to different temperature levels in the uf-HCT during initial heat up).

The present invention is configured to help lower preexisting levels of emission reduction (cumulative as well as particular problem regulation regions faced due to the uf-HCT, as in light-off desorption and the associated increase in pollutants at this stage). Also, with an improvement in pollutant removal for a given system there goes hand-in-hand the potential of achieving a reduction in catalytic material loading as in the expensive PGMs (platinum group metals inclusive of ruthenium, rhodium, palladium, osmium, iridium, platinum or any combination of the same).

The help in the reduction of such emissions also correlates with reductions in PGM loadings for the close-coupled catalysts, as the high Pd loads are typically required for improved cold start HC light-off. By using the emission system 30 of the present invention there can be achieved reductions in cold start HC emissions, such that lower PGM loadings in the CC catalyst can now be used. For example, a removal of up to 100 g/ft³ of PGM from the CC catalyst can be undertaken in some environments with the current system as opposed to operation without the present extended lean control with the emission system 30 configurations. For some applications, nearly all HC emissions come out in the cold start part of the FTP test with close to 100% conversion after the catalysts turns on at 10-20 seconds. In the present invention when PGM such as Pd is utilized, preferably all the Pd (and, to a lesser extent Rh) targets getting the catalyst just to light-off. In some cases the Pd can be as high as 300 gift³. In these type applications, the HC trap in the UB location may allow very large reductions in PGM usage.

In addition, the present invention also provides for avoidance of (or less reliance on) the oft utilized engine calibration technique of aggressive spark retard settings that are used in order to promote a late burning of the air and fuel charge, so that it is still in the process of combusting when it reaches the catalyst. While this is an effective way to warm up/light off the exhaust, it wastes energy (fuel). The present invention with its controlled supplemental oxygen supply avoids a requirement for this sort of retarded spark strategy. The NVH (noise, vibration and harshness) of the engine has the potential to improve with less aggressive spark timing and engine speed settings as well.

Timing of air injection (oxygen supplementation) relative to the above described P2 injection point positioned upstream or at uf-HCT with a given P2 value within about 6 cm of the uf-HCT inlet, is designed to initiate, at the proper time, an oxygen supply at uf-HCT to achieve the emission reduction of described HC's. That is, relative to the injection point at location P2, the initiation of supplemental oxygen supply should be timed to achieve a good O₂ amount and good intermixing of the supplemental oxygen in the exhaust gases passing to the uf-HCT at the appropriate temperature. The timing of supplemental oxygen supply at P2 is designed relative to the anticipated light-off temperature at the uf-HCT (e.g., an oxygen supply timed to reach the uf-HCT at a time of completion of the adsorption stage and start of the desorption stage and has a duration designed to sufficiently remove the anticipated or sensed level of HC adsorbed during the HC adsorption stage, as in associated HC build up in the uf-HCT during a cold start stage). Duration ranges for the period of oxygen supplementation include a sufficient amount of time to provide to the exhaust gas passing to the uf-HCT a suitable amount of oxygen to offset losses experienced upstream as in the losses incurred due to, for example, cc-TWC system operation upstream (as seen from FIG. 8 the initiation of supplemental oxygen supply for the test system occurs at about 65 seconds and ends at about 135 seconds). From a different perspective, the start point, duration and end point timing is designed to meet the above described beneficial oxygen supplementation to be timed with the initiation of the desorption zone which occurs when the light-off temperature of the uf-HCT is reached (as in the light-off temperature of a catalyzed (TWC upper layer) uf-HCT (thus the anticipated time to reach light off can also be used by the CU for oxygen supplementation as in a time just prior to accommodate any lag in supplemental oxygen reaching the uf-HCT).

That is, under embodiments of the invention, the initiation of oxygen supplementation can take place at a point prior to anticipated light-off (as in a controller CU based monitoring of received temperature increase levels for a given system, or a prescheduled (modeled) initiation point programmed into the system based on known parameters associated for a given system, or stored prior history data for the vehicle that is continuously updated to accommodate for loss in catalytic levels over time). With the FIG. 8 embodiment there is a 70 second supplementation period of oxygen supplementation supply. That is, FIG. 8 shows that at 65 s HC adsorption stops , and HC desorption starts and air injection starts. FIG. 8 also shows that at about 135 s, air injection is stopped, while desorption is still on-going (till the desorption stoppage point at around 200 seconds). Thus, the control unit is designed to coordinate the presence of sufficient supplemental oxygen at the uf-HCT at the initiation of desorption (e.g., the light-off initiation point). This supplementation timing, wherein the oxygen supply corresponds with initiation of light off (e.g., at 65 s) is an illustration of a preferred embodiment, although other embodiments of the invention are inclusive of the initiation of oxygen supplementation only after a light-off temperature start is sensed (although this process mode can delay the oxygen supply supplementation and can lead to some inability to fully remove pollutants at the start of initiation due to the lack of sufficient oxygen just when desorption HC's are initially released). With a preferred lead time for some considered systems under the present invention, the supply time is initiated, for example, within 5 seconds before anticipated light off Also, the timed range of air injection and termination of air injection (e.g., 65 s to 135 s), provides a flow “plug” of enhanced oxygen exhaust gas that operates to remove HC's released by the uf-HCT in an effort to achieve LEVIII removal standards without high PGM levels. This flow plug initiated timing and length range can be based on modeling by the CU.

There is also featured a control unit that can feather or adjust the amount of O₂ supply during the air injection provided during the desorption phase of the uf-HCT. It is noted that the depicted temperature sensor at the outlet bed of the uf-HCT is particularly informative of CTA system status relative to when desorption is initialized or ongoing (preferably, but still optionally, in conjunction with modal sensing of emission composition) in that the HCT acts like a chromatographic column, HCs are desorbed from the hotter front of the brick only to re-adsorb in the cooler rear sections until the rear is sufficiently hot to desorb them completely and they leave the trap in the exhaust. Accordingly, with respect to control emission system 30 of the present invention, a highly informative temperature for the controller is the HCT's outlet bed temperature. Further, with knowledge of this scenario of desorption at the hotter front end and partial adsorption at the downstream end of the uf-HCT, at certain temperatures, followed by complete desorption rates when a downstream temperature of the uf-HCT precludes re-adsorption, the control unit CU can be set relative to the injection air input to coordinate with this desorption rate change (e.g., a ramping up of the air amount after a lower, initialization of supplemental air input when there is partial re-adsorption on going at the downstream end of the uf-HCT). The use of different modal sensors or other temperature sensors (with or without the temperature sensor at the outlet region of the uf-HCT) can also be relied upon as in extrapolation from other temperature location, computer modeling, etc.

Furthermore, in addition to the above desorption rate differential during the time the uf-HCT is fully heating up, other factors can be considered in the control unit CU controlling of air injection as in the amount of lead time in oxygen supplementation and the cut-off point is dependent to some extent on the flow rate of exhaust, and the pump air injection flow rate (as metered by air meter 86), the uf-HCT composition, the current temperature as well as other factors including the length between point P2 and the upstream end of uf-HCT.

With reference again to FIG. 8 there can be seen that the two systems (with oxygen supplementation and without oxygen supplementation) described above were tested according to the test characteristics described above and the cumulative emissions into the uf-HCT were measured (the THC “reaching” the trap during the various cycles and stages during the 500 second period were measured (with the amount being applicable to both tests). FIG. 8 also shows the THC measurements after (downstream) of the uf-HCT when the test run did not include the supplemental oxygen (run “a)”) and the measurement of the THC after (downstream) of the uf-HCT when the test run did include the supplemental oxygen (run “b)”).

FIG. 8 clearly shows that once the desorption period starts, the present invention embodiment with the controlled supplemental oxygen supply means (run “b)”) “plug” of oxygen addition is able to maintain, after desorption starts, a much lower level of THC emissions as compared to the run “a)” comparison run (compare the circles 2 and 3 in FIG. 8 graph lines). This differential and improvement made under the present invention is even more pronounced when the respective systems reach a smoother (more steady state) period as seen around the 240 second mark, wherein the respective data lines for each of run “a)” and “b)” show about a 30% reduction in THC emissions which continues on after during the noted “more steady-state” time period of 240 seconds to 500 seconds (after the end of the desorption period). In other words, as seen from FIG. 8, during the more steady state period there is a THC level in the emissions reaching the uf-HCT of about 0.010 g/mi which rises to some extent to about 0.0104 g/mi at the 500 second cut-off of data. Run “a)” downstream of the HCT shows a reduction by the catalyzed uf-HCT down to about 0.0088 g/mi during the “steady-state” period following desorption initiation. Run “b)”, with the supplemental oxygen provided strategically as described above, shows THC emission levels downstream of the HCT having been reduced by the catalyzed uf-HCT down to about 0.0062 g/mi during the “more steady-state” period following desorption initiation. Accordingly, the CTA with oxygen supplementation means of the present invention is shown as having generated about a 30% reduction in THC traveling downstream of the uf-HCT which provides for greater flexibility in meeting the more stringent regulated levels as in those imposed by LEVIII as well as greater flexibility with respect to catalytic material loading (e.g., as in a lowered amount of PGM required in the washcoating of the cc-TWC and/or catalyzing material associated with the uf-HCT (as in the upper layer shown in FIG. 3A)).

FIG. 8 also shows a rough correlation between engine speed (as driven by the FTP cycling and natural heat build-up over time) and the HC Trap fixed bed temperature. These items of engine speed and HCT temperature can be monitored by control unit CU and can be used to help in coordinating the initiation and length and amount of supplemental oxygen supply inclusive of use in establishing in potential mapping and storage parameters shown to be best suited for a given engine operation and engine and catalyst states. Reference is also made to the above discussion as to the tendency for there to be some re-adsorption during initial stages of desorption when there is a temperature differential along the length of the uf-HCT during its heating up after initial engine ignition.

FIG. 9 shows a comparison of O₂ levels (ppm) between runs “a)” and “b)”. Again there is provided a 500 second FTP snap-shot in time with the roll speed cycling shown based on the regulated cycling of vehicle speed in the FTP (shown as the lighter shaded data lining in FIG. 9). FIG. 9 further shows how under the conventional approach there is lacking O₂ levels for achieving proper emission treatment of pollutants relative to a desorbing uf-HCT that is triggered upon the temperature of the uf-HCT reaching light-off. As seen by the flat 0 level graphing of the O₂ levels from 20 seconds to the first spike at about 310 seconds, there is a deficient amount of O₂ flowing into the uf-HCT during this time period. That is, FIG. 9 illustrates that there is essentially no O₂ present with the stock or conventional calibration due to the lack of fuel cuts and the activity of the cc-TWC removal of engine-out O₂. Further, the first spike at about 310 cycles represents the initial DFCO activity which is featured in DFCO controlled engines as this point is the first time that DFCO operation takes place relative to conventional engine control and fuel cut off parameters, and the first time under conventional engine running that O₂ levels are available post desorption.

On the other hand, under the method and emission system 30 (with emission system 30 in FIG. 7 showing an example of system 30 using an ambient air injection apparatus as a supplemental oxygen supply means and coordinating control unit CU) there can be seen the initiation of oxygen supplementation at around 65 seconds in on the FTP program provides for oxygen levels reaching the uf-HCT of greater than 50,000 ppm, with a value of range of 50,000 ppm to 150,000 ppm being illustrative of sufficient oxygen supply levels at this point relative to some engine types; and with, 70,000 ppm to 130,000 PPM of O₂ concentration being well suited for a variety of contemplated engines like those described above for providing suitable oxygen supply to enable efficient removal of desorbed HC's as well as other pollutants passing in the exhaust. Also, the oxygen supplementation can be based on a constant flow (once triggered and for a real time determined or predetermined time period). The air flow can be controlled by a control unit CU and air meter coordination. That is, air flow to the exhaust line to supply the desorbing uf-HCT with the supplemental oxygen can be determined by a metering device (e.g., air meter 86 shown in FIG. 5).

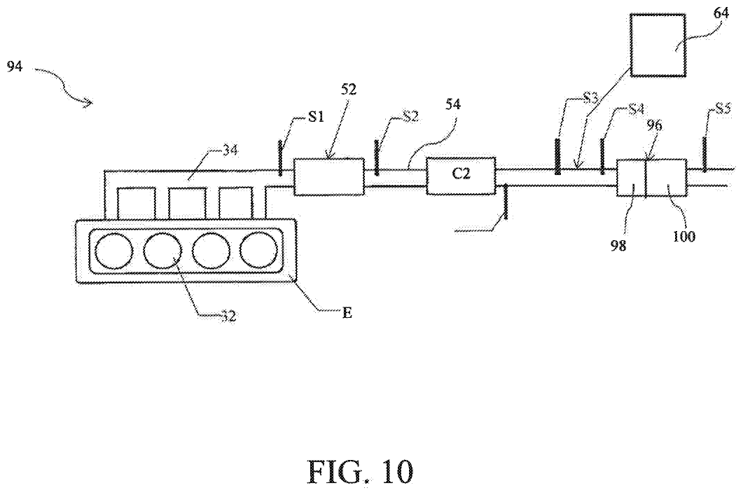

FIG. 10 provides an illustration of a modified emission system 94 having similar components as described above for system 30 (with like references repeated here relative to previously described invention components) as in an engine E that is predominately or entirely gasoline based in this embodiment, and with a plurality of sensors strategically positioned as in S1 to S5 (which can share attributes with the modal (M1 to M3) and associated thermocouple temperature sensor TS1) described previously as feeding pertinent information to control unit CU and/or ECU (not shown in FIG. 10).

FIG. 10 further shows the upstream or close coupled “cc” system (as in the cc-TWC 52 described above having one or more catalytic components that are preferably each of the cc-TWC type and/or of the OC type). FIG. 10 further shows the above described oxygen supplemental oxygen supply means 64 injecting supplemental oxygen (e.g., air as in ambient air) at a location upstream of a modified catalyzed uf-HCT 96.

FIG. 10 further illustrates an optional added component C2 placed in the exhaust line 54 downstream of first component 52 (e.g., one or more cc-TWC's or oxidation catalyst (OC)), C2 can be, for example, a cc-HCT, SCR, GPF, NSC, etc.) and upstream of the uf-HCT 96. The function of C2, if present, can be dictated by the engine system and other requirements as in emission reduction level criteria. Also, again, depending on the nature of the emission treatment system involved, the above referenced C2 components can also be present downstream of the uf-HCT (as a replacement to the illustrated upstream or as a supplement to the upstream C2 component—as in the discussion of components 100 below).

With respect to the above mentioned modified uf-HCT system 96, which is shown as being zoned with an upstream (common substrate or common canister or an upstream separate component with own substrate support) catalyzed uf-HCT 98 is followed by a second component 100 that can take on a variety for forms depending on desired usage and the engine system characteristics for example.

An alternate embodiment features 98 and 100 as independent components as in a catalyzed uf-HCT and a downstream added emission component such as a combination OC-Catalyzed uf-HCT and a downstream NSC or SCR (with or without supplemental reductant supply to the SCR) with an example being having the oxygen supply sufficient to remove most HC's while having a sufficient supply of non-reacted HC's for SCR reduction with excess NOx.

It should be further noted that the terms “first”, “second” and the like herein do not denote any order of importance, but rather are used to distinguish one element from another, and the terms “a” and “an” herein do not denote a limitation of quantity, but rather denote the presence of at least one of the referenced items. Furthermore, all ranges disclosed herein, unless stated otherwise, are inclusive and combinable e.g., ranges set forth in the present description include endpoints and all intermediate values of the ranges, e.g. a point P2 supplemental air injection location upstream of the uf-HCT can range from 8 cm to 0 cm with the endpoints included as well as each intermediate value (e.g., 1, 2, 3, . . . 7 cm) for the distance between the designated end points for the P2 location).

While the invention has been described in detail with reference to particular embodiments thereof, it will be apparent upon a reading and understanding of the foregoing that numerous alterations to the described embodiments will occur to those skilled in the art, and it is intended to include such alterations within the scope of the appended claims.

What is claimed is:

1. A system for a gasoline engine exhaust emission reduction, comprising:
an underfloor hydrocarbon trap (uf-HCT),
a supplemental oxygen supply apparatus feeding oxygen to the exhaust reaching the uf-HCT,
a control unit in communication with the supplemental oxygen supply apparatus as to feed oxygen to the uf-HCT during a time of HC desorption from the uf-HCT and wherein the control unit feeds the excess oxygen to the uf-HCT as to place the exhaust flow in contact with the uf-HCT in lean state.

2. The system of claim 1 wherein the control unit feeds excess oxygen to the uf-HCT by feeding air to the exhaust flow at an injected air mass flow rate into the exhaust passing to or in the uf-HCT of 1 to 30 L/s.

3. The system of claim 2 further comprising an added catalyzing material provided on the uf-HCT as to promote the removal of HC during the time of both HC desorption from the uf-HCT and control unit supplied excess oxygen.

4. The system of 3 further comprising one or more upstream catalyst(s).

5. The system of claim 4 wherein the one or more upstream catalyst(s) includes at least one TWC close coupled catalyst.

6. The system of claim 3 wherein the added catalyzing material includes a TWC coating layer provided on the uf-HCT.

7. The system of claim 1 wherein the control unit receives input from one or more sensor units as to establish an anticipated or an on-going state of HC desorption from the uf-HCT and a signal generator as to promote oxygen feed from the supplemental oxygen supply apparatus.

8. The system of claim 7 wherein the supplemental oxygen supply apparatus comprises an air feed assembly.

9. The system of claim 8 wherein the air feed assembly feeds ambient air to the uf-HCT.

10. The system of claim 1 wherein the engine is a gasoline engine selected from the group consisting of a port-fuel injection (PFI) engine, a stratified charge engine (SCE), a gasoline direct engine (GDI), a dual injection system engine (PFI+GDI), a gasoline direct injection compression ignition engine (GDCI) an engine with start stop control reception, an engine which is a component of a vehicle multi-power drive system.

11. The system of claim 10 wherein at least a component of the air feed assembly shares a component of an air feed system to the engine.

12. The system of claim 11 wherein the component of the air feed assembly shared with the air feed system to the engine includes a vacuum exhaust valve.

13. The system of claim 1 wherein the control unit is configured to rely on a modeled uf-HCT condition for initiating supplemental oxygen supply to the uf-HCT.

14. The system of claim 1 wherein the uf-HCT comprises a (molecular-sieve) material as well as a PGM metal that comprises Pd and a base metal addition inclusive of Fe.

15. The system of claim 14 wherein the uf-HCT further comprising a catalyzing material that includes a TWC coating layer provided on the uf-HCT, wherein the TWC coating comprises Rh.

16. The system of claim 1 wherein the control unit initiates oxygen supplementation within 5 seconds of initiation of light off or at light off, and extends a supplemental oxygen supply period until a predominate amount of HC or all of the HC has been oxidized during a desorption period of HC from the uf-HCT.

17. A system for a gasoline engine exhaust emission reduction, comprising:
an underfloor hydrocarbon trap (uf-HCT),
means for supply supplemental oxygen to the uf-HCT,
a control unit in communication with the means for supplying oxygen to the uf-HCT during a time of HC desorption from the uf-HCT.

18. A method of assembling the system of claim 1 comprising:
presenting a hydrocarbon trap (HCT) in an underbody position (uf-HCT) of a vehicle exhaust conduit,
presenting a supplemental oxygen supply apparatus as to feed supplemental oxygen to the uf-HCT,
presenting a control unit in communication with the supplemental oxygen supply apparatus as to feed oxygen to the uf-HCT during a time of HC desorption from the uf-HCT as to place the exhaust in a lean state over the uf-HCT.

19. The method of claim 18 further comprising presenting a close coupled TWC (cc-TWC) and the uf-HCT is a catalyzed uf-HCT with both Pd and a TWC coating having Rh.

20. A method of operating the system of claim 1 comprising passing exhaust gas over the uf-HCT and controlling the supply of supplemental oxygen to the uf-HCT by operation of the control unit and the supplemental oxygen supply apparatus to remove desorbing hydrocarbons from the exhaust flow.
